(19) United States
(12) Patent Application Publication
(10) Pub. No.: US 2002/0046093 A1
(43) Pub. Date: Apr. 18, 2002

(54) System, method, and article of manufacture for targeting and delivering sales information

(76) Inventors: Michael Robert Miller, Coral Springs, FL (US); Gregory Paul Miller, Coral Springs, FL (US); William H. Carpenter JR., Severna Park, MD (US)

Correspondence Address: Anthony R. Barkume, Esq., Greenberg Traurig, LLP, 21st Floor, 885 Third Avenue, New York, NY, 10022, US

(21) Appl. No.: 09/783,950

(22) Filed: Feb. 14, 2001

Related U.S. Application Data
(63) Continuation-in-part of application No. 09/296,479, filed on Apr. 22, 1999.

(51) Int. Cl. G06F 17/60; G06G 7/00; G06F 17/00

(52) U.S. Cl. 705/14; 705/400

(57) ABSTRACT

A system, method and article of manufacture are provided for distributing targeted sales information. User input relating to products is stored in a database. A request to send sales information associated with a product is received. The database is searched for selecting users who have entered user input relating to the product associated with the sales information. The sales information is output to the selected users. A fee is charged for outputting the sales information.

### FIELD OF THE INVENTION

The present invention relates to computer systems and electronic commerce and more particularly to utilizing bar codes for gathering and disseminating information.

### BACKGROUND OF THE INVENTION

Bar codes have long been used to identify items such as consumer goods and/or a manufacturer or producer of such items. Bar codes come in many types or formats. They range from one-dimensional codes (in which the graphical pattern of a bar code contains meaningful data when scanned in one dimension) such as the ubiquitous UPC (Universal Product Code), the POSTNET scheme used by the U.S. Postal Service, Code 3 of 9, etc., to two- and even three-dimensional codes. Three-dimensional codes may also be known as radio frequency codes.

The information represented by a one-dimensional bar code may be as simple as a string of numbers and/or letters and other characters that identify an item and/or a source of an item. Two and three-dimensional bar codes may contain a wealth of other data concerning a bar coded item. For example, a two-dimensional bar code format known as PDF417 can store over one kilobyte of information in a single symbol. As its name implies, a two-dimensional bar code contains meaningful data when scanned in two dimensions.

Bar code readers, or scanners, come in a variety of shapes and forms. Bar code scanners may be portable or fixed in place. They may be a component of a larger device (e.g., a computer or digital assistant) or self-contained (e.g., a wand that can read a bar code and store it internally or transmit it to another device).

The usefulness of bar codes has generally been limited to internal operations of business entities. Bar codes have been used, for example, to facilitate the tracking of inventory, to identify a product for re-stocking, to look up the price of an item when a consumer purchases it, to monitor the status of a shipment or delivery (e.g., by tracking its location) etc. In other words, bar codes have not generally been of use to consumers except to facilitate the purchase or delivery of an item bearing a bar code.

Although a bar code may uniquely identify an item (or set of items) that are of interest to a person, he or she generally has no way to access information concerning the item from the bar code itself. The person may be limited to traditional information sources, such as a salesman, the item's packaging, etc. The lack of easy access (e.g., automated, electronic) to data concerning a bar-coded item is especially noteworthy concerning the proliferation of information generally available to consumers. In particular, the ever-growing use of computers and other electronic devices and communication routes between such devices (e.g., the Internet) means that an abundance of information is available to consumers, but that bar codes presently do not serve as an entrance point to this wealth of data.

Thus, what is needed is a system and method for enabling a person to access information concerning an item of interest to that user (e.g., a consumer good, an article or document) or an opportunity to purchase such an item by scanning a bar code associated with that item. What is also needed is a method for an entity that deals in items having bar codes (e.g., a manufacturer, vendor) to specify information that may be provided to a person who scans a particular bar code. Further, there is a need for a system and methods for gathering and using information about consumers who use the items. To meet these needs, a system capable of receiving bar codes or bar code representations, storing them and relevant information concerning items corresponding to the bar codes, and displaying such information upon demand is also required.

### SUMMARY OF THE INVENTION

A system, method and article of manufacture are provided for distributing targeted sales information. User input relating to products is stored in a database. A request to send sales information associated with a product is received. The database is searched for selecting users who have entered user input relating to the product associated with the sales information. The sales information is output to the selected users. A fee is charged for outputting the sales information.

In one embodiment of the present invention, the user input includes submissions of representations of bar codes associated with products. Thus, a defined group that has already opted into the product set by scanning a barcode is sampled.

In another embodiment of the present invention, the sales information is output utilizing a web page. An additional fee is charged for selecting a positioning of the sales information on the web page. For example, a premium can be charged for top-center positioning on the web page.

In an embodiment of the present invention, the sales information is output to a client device of one or more of the users. Such client device can be: a personal computer, a scanner with a display mechanism, a portable computing device such as a laptop computer, PDA, etc., a wireless or hard wired telephone, a pager, a facsimile machine, etc.

An additional fee can be charged for outputting the sales information to a telephone, pager, and/or portable computing device. A premium can also be charged for the delivery of first position to cell phones, pager, telephone, etc.

As an option, a user response to the sales information can be tracked. As another option, a promoter (i.e., vendor, manufacturer, marketer, etc.) of the product can be allowed to provide dynamic feedback to a user who is responding to the sales information.

### BRIEF DESCRIPTION OF THE DRAWINGS

The invention will be better understood when consideration is given to the following detailed description thereof. Such description makes reference to the annexed drawings wherein:

FIG. 1 is a block diagram depicting a system for receiving a representation of a bar code and producing information related to a product, service or other item associated with the bar code in accordance with an embodiment of the present invention.

FIG. 2 is a flow chart demonstrating one method of using the system depicted in FIG. 1 in accordance with an embodiment of the present invention.

FIGS. 3A-3B comprise a flow chart demonstrating one method of registering a bar code or information to be associated with a bar code with the system depicted in FIG. 1.

FIG. 4 is a flow chart of a process for providing product information to a user while maintaining the anonymity of the user.

FIGS. 5A and 5B illustrate an exemplary portal page for presenting product and/or promotional information to a user.

FIG. 6 is a flow chart that illustrates a process for generating a website based on input of bar code information.

FIG. 7 is a flow diagram depicting a process for driving navigation to a particular web site.

FIG. 8 is a flow diagram that depicts a process for allowing selection of products while navigating multiple websites.

FIG. 9 is a flow chart that illustrates a process for matching products to a textual request according to an embodiment of the present invention.

FIG. 10 is a flow chart illustrating a process for selecting a vendor of a product according to one embodiment of the present invention.

FIG. 11 is a flow diagram of a process for selecting a vendor based on a list of user-selected products.

FIG. 12 is a flow chart depicting a process for alerting a user to a promotional offer for a product.

FIG. 13 is a flow chart setting forth a process for presenting product information.

FIG. 14 is a flow diagram depicting a process for generating a list of desired products for presentment to a person other than the user desiring the products.

FIG. 15 is a flowchart of a process for targeting a promotion to a user based on a user-entered product identifier.

FIG. 16 depicts a process for generating a promotional offer for a product.

FIG. 17 illustrates a process for delivering a promotional offer according to an embodiment of the present invention.

FIG. 18 is a flow diagram depicting a process for distributing targeted sales information.

FIG. 19 is a flow chart setting forth a process for promoting entertainment programs.

FIG. 20 is a flow diagram of a process for allowing bidding on products.

FIG. 21 depicts a process for test marketing in real time based on user polls.

FIG. 22 is a flow chart depicting a process for bar code-based electronic commerce.

FIG. 23 illustrates a process for presenting a recipe based on bar code information.

FIG. 24 depicts a process for presenting ingredients of a recipe based on bar code information.

FIG. 25 is a side view of a bar code scanning device according to an illustrative embodiment of the present invention.

FIG. 26 is a perspective view of the bar code scanning device with keys attached.

FIG. 27 is a perspective view of a docking station that can be used to transmit the bar code information stored in the scanning device to a host computer.

FIG. 28 is a schematic diagram of a hardware implementation of one embodiment of the present invention.

### DETAILED DESCRIPTION OF THE PREFERRED EMBODIMENTS

The following description is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed below are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program and hardware environment in which an embodiment of the invention is executed is set forth below. In particular, a bar code scanner may be used in one or more embodiments of the invention. Suitable scanners may take a variety of forms and be portable or fixed in place. They may also be incorporated into or operate in conjunction with other devices or functions (e.g., hand-held or desktop computer) or may be capable of independent operation.

It should also be understood that the techniques of the present invention might be implemented using a variety of technologies. For example, the methods described herein may be implemented in software running on a computer system, or implemented in hardware utilizing either a combination of microprocessors or other specially designed application specific integrated circuits, programmable logic devices, or various combinations thereof. In particular, methods described herein may be implemented by a series of computer-executable instructions residing on a storage medium such as a carrier wave, disk drive, or computer-readable medium. Exemplary forms of carrier waves may be electrical, electromagnetic or optical signals conveying digital data streams along a local network or a publicly accessible network such as the Internet. In addition, although specific embodiments of the invention may employ object-oriented software programming concepts, the invention is not so limited and is easily adapted to employ other forms of directing the operation of a computer.

In one embodiment of the invention a system and method are provided for receiving a representation of a bar code scanned by a user (e.g., a digital translation or equivalent). Upon receipt of the bar code or bar code representation, the system retrieves one or more pieces of information concerning a product, a document, or other item (e.g., an identification tag, a part or piece of equipment, a coupon, a license, a form, a manual or book, etc.) that corresponds to or is associated with the bar code. For example, when a bar code appearing on a consumer product is scanned and received at the system, a description of that product or other information such as a hyperlink to an electronic location containing additional details concerning the product may be returned. In particular, an electronic commerce opportunity might be offered.

Illustratively, the system may report a price of the product, a link to a location at which it may be purchased, information concerning competing or alternative products, etc. Thus, simply by scanning a bar code associated with an item a user is interested in, he or she is provided with a variety of data concerning the item. Scanned bar codes, or bar code representations, may be stored prior to transmission to the system in a bar code scanner or a user's computer that is capable of communication with a scanner. The bar codes or representations may be collected during the execution of a set of instructions (e.g., a software or firmware program) operating on the user's computer (e.g., a web browser, utility application, operating system, etc.).

In another embodiment of the invention, merchants and/or producers of items that are or will be associated with a bar code register the appropriate bar codes with the system. In this embodiment the merchant/producer may supply certain information or links to be provided to all or a subset of users who scan a particular bar code. For example, a manufacturer of a product may select a new UPC (Universal Product Code) bar code for use with a new product. By registering that UPC code with the system, a user can be directed to a network location associated with the manufacturer and/or the specific product. A network location may, for example, be specified as a network address or URL (Uniform Resource Locator).

Other entities may also identify bar codes that are of interest to them for the purpose of displaying appropriate advertisements or for inviting electronic commerce transactions concerning the products associated with the bar codes or the entities' competing or alternative products. In the example above, a merchant that offers the manufacturer's product for sale may indicate to the system its desire to be identified as a vendor to a user interested in the product. This vendor may therefore request or purchase the right to be identified to a number of users who scan the product's bar code and submit its representation to the system.

In yet another embodiment of the invention, an entity may desire a unique or semi-unique bar code for use with a certain product, document or other item. Thus, the entity may purchase or lease a bar code and register it with a system operating an embodiment of the present invention. Illustratively, the entity connects to the system, identifies its desire for a unique code and a new code is generated by the system and downloaded to the entity (e.g., as a graphics file). The entity may then use that bar code with the desired item or set of items. And, when a user scans the bar code and submits its representation to the system, information registered with the system by the entity may be provided to the user.

In one embodiment, a system may transmit information relevant to a user's item of interest to the user in a form suitable for display as part of graphical user interface, such as a “portal” page (e.g., a web page containing hyperlinks to other information or web locations). A portal page in this embodiment may comprise a set of graphical, audio and other components that are retrieved and forwarded to the user in response to the user's transmission of bar code representation. The page components may be pre-selected or dynamically selected on the basis of various criteria, such as the identity of the operator of the system or the provider of the user's bar code scanner or an entity associated with a bar code scanned by the user. In particular, the various portal page components and item information that are displayed for a user may depend upon contractual or other arrangements between the operator of the system and various manufacturers, producers, vendors and other entities that wish to have users view their designated component or information.

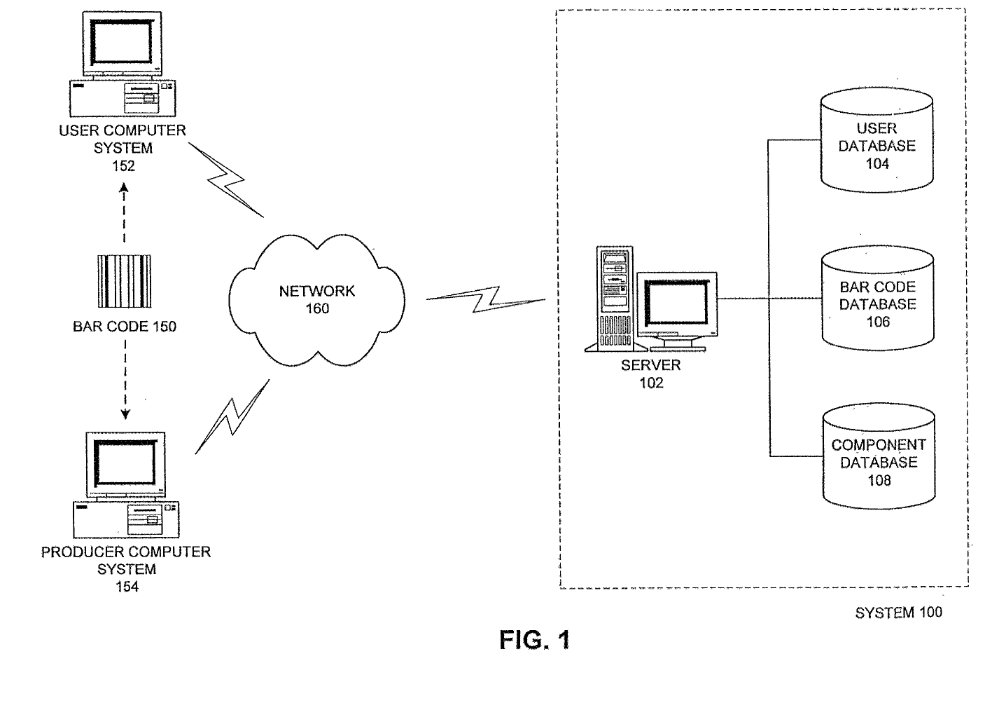

FIG. 1 depicts an illustrative system and environment in which an embodiment of the invention may be implemented. It will be understood that alternative embodiments may be implemented using systems and computing environments having varying degrees of similarity to FIG. 1. In particular, systems for practicing the present invention may be incorporated in centralized or distributed computing environments using virtually any type or configuration of computing devices. A typical system will, however, comprise one or more computer servers or systems for facilitating the generation of appropriate portal pages, depending on a user's item(s) of interest.

In FIG. 1, system 100 comprises server 102 configured to receive bar code representations from users and return information concerning products, items or entities associated with the bar code(s). Server 102 is also configured to receive representations of bar codes from producers, merchants and other entities wishing to provide information concerning, or be associated with in some other manner with, the products or items that correspond to the bar codes.

The various functions performed by server 102 may, in an alternative embodiment of the invention, be distributed among a plurality of servers. For example, a web, “http” (hypertext transport protocol) or “content” server may be employed to assemble and/or transmit information to be displayed for a user. An administrative server may be employed to handle maintenance of or updates to the databases used in system 100 (e.g., such as when a producer registers a new bar code or product). Also, one or more servers may be employed to operate the system's databases. In particular, a separate database server may be implemented for each database.

Three databases are depicted in FIG. 1: user database 104, bar code database 106 and component database 108. Alternative embodiments are not limited in the number of databases or database servers they may use. One alternative embodiment may, for example, aggregate all data into one unified database. The various types of data and information may be stored in separate database tables. User database 104 in the illustrated embodiment stores personal and/or historical information concerning users of system 100. In particular, user database 104 may store identifying data concerning a user (e.g., name, account name, email, network address), profile data (e.g., age, geographical region of residence or work) and historical data concerning the user's activity or interaction with system 100. In addition, the bar codes scanned by the user and presented to system 100 may be stored in user database 104, perhaps for the purposes of analysis and/or categorization. In particular, based on the bar codes scanned by a user, system 100 may determine the types of products/items the user is interested in and therefore enable the accurate targeting of advertisements, marketing and electronic commerce opportunities to the user.

Bar code database 106 in the illustrated embodiment contains bar codes and/or representations of bar codes. For each bar code registered in the database, one or more pieces of information (e.g., URL of an appropriate network site, item description, electronic commerce opportunity, advertisement, product review) are also stored or identified. The bar codes known to database 106 in this embodiment include both public domain codes (e.g., UPC) and proprietary codes (e.g., those generated by system 100 for requesting entities). Representations of one, two and three-dimensional bar codes may be stored in bar code database 106, in any suitable form.

The amount of information concerning a bar-coded item that is stored in bar code database 106 may depend upon the producer or entity associated with the item, the type or form of bar code, and other factors. A UPC (Universal Product Code) code, for example, includes an identifier of an item's producer. The system may therefore store a link or reference to a suitable source of information (e.g., the producer's World Wide Web site) for all, or many, UPC symbols. The producer may, however, decide to register additional information concerning one or more items with system 100. Then, when a user submits a representation of a UPC for one of these items, tailored information (e.g., a specific page of the producer's web site) can be identified to the user. Other types of bar codes (e.g., non-public domain codes that are not generated by system 100) may not be recognized by the system, thereby limiting the information that can be provided to an interested user to that which is specifically registered by an interested entity (e.g., producer or vendor of an item having an unrecognized bar code, or a competitor of such a producer or vendor).

As already described, bar code database 106 may store information to be displayed for the user that is related to an item associated with a bar code scanned by a user.

Alternatively, bar code database 106 may simply identify such information by its location elsewhere than on system 100. Illustratively, after a user provides one or more bar code representations to system 100, a description of the item (e.g., name of a product, title of a document) is retrieved for display to the user along with the related information. Thus, the user may be presented with various information concerning an item he or she is interested in along with links to additional information concerning the same item or an alternative item (e.g., where to buy, cost).

Component database 108 in FIG. 1 stores components of portal pages, web pages or other graphical displays to be provided to one or more users. The components stored in component database 108 may not be tailored to particular items corresponding to bar codes scanned by a user but may, instead, be tailored to specific entities (e.g., manufacturers, producers, vendors, competitors, information aggregators or providers). In other words, the components identified by content database 108 are not necessarily determined by any of the bar codes scanned by the user.

Components stored in component database 108 may include text, graphics, sounds, animations, designs, hyperlinks, etc. They may be stored as executable files, objects, documents or in any other suitable form. One skilled in the art will appreciate that the types of components (and item information stored in bar code 106) may include virtually anything that can be transmitted from one computer to another for presentation to a user. The components assembled and displayed for a user in a particular portal page may be determined ahead of time with an operator of system 100 or may be selected at about the time that a user connects to the system and submits a bar code representation.

The components drawn from database 108 may be retrieved based on the identity of a particular entity. For example, in one embodiment of the invention system 100 may be operated by a particular organization. That organization may choose to display its own advertisements for every user regardless of the items the user scans. A portal page generated by system 100 in this embodiment may thus be tailored to the operator of the system. In another embodiment of the invention, along with the bar code representation(s) received from a user, system 100 may also receive an identifier of a particular entity such as the entity that provided the bar code scanner employed by the user or the entity that provided the computer system, communication line or software used to transmit the bar code representation(s), etc. A portal page generated for a user in this embodiment may thus be tailored to the identified entity.

The various portal page components and pieces of information concerning an item having a bar code scanned by a user may be assembled for display to the user according to one or more templates. These components and/or pieces of information may, in turn, include templates for displaying sub-elements of the components or information.

A template may describe a portion of a user interface (e.g., a portal or other web page) to be viewed on the user's display or monitor. For example, one template may comprise a banner section to be populated from component database 108 on the basis of the identity of the entity that provided the user's bar code scanner and/or the operator of system 100. Another section of the template may be configured to include one or more advertisements or links to advertisers—illustratively retrieved from component database 108 and/or bar code database 106. Another, primary, section of the template, however, should consist of information drawn from bar code database 106. As described above, in this section would appear information (e.g., description, title, summary, review, commerce opportunity) relating to the bar codes scanned by the user.

Due to the amount of information to be included in this primary section, it may incorporate a link or extension to another page or template that will display additional information. For example, a first portal page displayed to a user may identify a number of items whose bar codes were scanned by the user and transmitted to system 100. For each item a description (or link(s) to sites containing descriptions) may be provided. In addition, the first portal page may include links to one or more follow-on pages for the purposes of presenting electronic commerce opportunities and/or other information. On these follow-on pages may appear one or more costs of an item from one or more vendors, costs of competing or alternative items (with or without descriptions and vendors), a tool for tracking a user's purchases or items of interest, etc.

Returning now to FIG. 1, network 150 is a communication medium through which system 100 can communicate with user computer system 152 and/or producer computer system 154. Illustratively, network 150 is the Internet, although other public or private networks, local or wide-area in nature may be substituted. Network 150 may be of any suitable topology and operate virtually any protocol or protocols. In one alternative embodiment of the invention, network 150 is replaced as a communication medium by point-to-point links between system 100 and user computer system 152 and/or between system 100 and producer computer system 154. One skilled in the art will recognize that any effective means of communicating between a computer system and system 100 may be implemented. In particular, system 100 may include any number of computers for communicating with users and other entities and may communicate through a firewall, a proxy server or other means of separating, isolating or securing communications.

User computer system 152 and producer computer system 154 may be hand-held, notebook, laptop, desktop, workstation or other computer systems suitable for operation by one or more individuals. In the illustrated embodiment, a primary distinction between user computer system 152 and producer computer system 154 is the purpose of its connection to system 100. In particular, user computer system 152 is configured and employed to submit one or more bar code representations to system 100 and retrieve related information, as described above. User computer system 152 therefore receives and displays information sent from system 100 for a user operating the computer system. The information may be presented in the form of one or more portal pages or other user interfaces.

User computer system 152 is specifically configured to scan a bar code or receive a bar code representation from a bar code scanner and to transmit a bar code representation to system 100. In one embodiment of the invention the computer system may incorporate a computer program or other series of executable instructions such as an applet or plug-in application suitable for use with a web browser or other user interface.

In this embodiment the program facilitates the receipt and storage of bar code (e.g., bar code representations) scanned by a user. The program may be configured to automatically launch a web browser (or other interface) and/or direct a browser to system 100. The program may be downloaded or updated from system 100, may be loaded in conjunction with the connection of a bar code scanner to the computer system, may reside in hardware (e.g., the bar code scanner) or firmware, etc.

In contrast to user computer system 152, producer computer system 154 is configured and employed to register bar codes (e.g., bar code representations) and/or portal page components with system 100. Thus, a product manufacturer, vendor, advertiser or other entity may register its own bar codes or bar codes generated by system 100 on its behalf. When registering a bar code with system 100, an entity illustratively identifies or supplies information to be displayed for a user who scans the bar code. As described above, this information may include a link to a product description, summary or review, a network location (e.g., web site or page), an advertisement, an electronic commerce opportunity, etc. Thus, bar code database 106 and component database 108 may be populated with information and portal page components submitted through producer computer system 154.

Bar code 160 may be any public domain (e.g., UPC, Code 3 of 9) or proprietary bar code (e.g., generated by system 100). Bar code 160 may or may not have accompanying alphabetic, numeric, alphanumeric or other characters that also represent the bar code. Although bar code 160 in FIG. 1 is a one-dimensional, bidirectional (e.g., can be scanned left-to-right or vice versa) bar code, multi-dimensional codes are also suitable for use with system 100 and may be unidirectional, bi-directional or other.

In a present embodiment of the invention a user may use a bar code scanner to scan bar code 160 (e.g., from a product, a document or other item) or may manually enter its associated character representation. The device used to scan a bar code may take any form or design and may be incorporated into other devices (e.g., hand-held computer, pager, wireless telephone). Some bar code scanners take the form of wands, pens, cards, hand-held devices, etc.

In one embodiment of the invention a bar code scanner is provided to a user and is configured to identify the provider of the bar code scanner when user computer system 152 connects to system 100 and transmits a bar code representation. In addition to sending an identifier of the scanner provider and one or more bar code representations during its communication with system 100, user computer system 152 may also send information identifying a person using user computer system 152 (e.g., name, account name, email address). For purposes of identifying a user and/or collecting historical information concerning the user's interaction with system 100, system 100 may store certain data (e.g., account name, profile, history of interaction with system 100) on the user's computer system (e.g., as a “cookie” or other collection of data retrievable by system 100). In alternative embodiments of the invention system 100 may also store portal page components and/or item information on user computer system 152. For example, components of the portal page that are tailored to the provider of the user's bar code scanner may be stored in order to increase the speed with which a portal page is displayed on the user's computer system. Components and item information downloaded to user computer system 152 may be updated or replaced during a later connection to system 100.

Although the embodiment of system 100 illustrated in FIG. 1 comprises three databases, in one particular embodiment of the invention five databases are employed. A first database, a client database, is similar to user database 104. A client database may store identification and activity data concerning a user. This data may include representations of bar codes scanned by the user, links or other information associated with the items corresponding to the scanned bar codes, etc.

In this alternative embodiment, a second database may be termed a code database and is similar to bar code database 106 of FIG. 1. Illustratively, the code database associates a bar code representation with an appropriate link (e.g., a hyperlink to an Internet URL) concerning an item that corresponds to the bar code. The link for a particular item may take the user to the web site of a manufacturer or vendor of that item or a particular page within the web site that addresses the item. Item descriptions, reviews, summaries, and other information concerning the item may also be stored in the code database. A primary function of the code database may be to identify a URL that is pertinent to an item whose bar code was scanned by a user.

The third database in this alternative embodiment is a content database similar to component database 108. This content database may store or identify links (e.g., hyperlinks) and/or advertisements for specific advertisers or partners of the entity that operates system 100. The advertisers/partners may register specific links and advertisements to be displayed in portal pages. As described above, a portal page is a page displayed to a user in response to his or her submission of one or more bar code representations to system 100. In this alternative embodiment a portal page is tailored to a particular entity, such as the provider of the user's bar code scanner, the operator of system 100 or an advertiser or partner having an agreement with the operator of system 100. Thus, the content database in this alternative embodiment contains portal page components (e.g., banners, advertisements, hyperlinks, graphics, animations) specific to one or more entities for which a portal page may be tailored. In particular, each entity that provides a bar code scanner to a user may specify components to be stored in the content database for tailoring its portal page. One distinction of portal pages in a current embodiment of the invention is that they are dynamically generated by system 100 and are thus not associated with, and cannot be reached via, a URL.

A fourth database in this alternative embodiment may be termed a commerce database. Illustratively, a commerce database maps a bar code (e.g., a bar code representation) to one or more vendors or other entities that wish to offer a user an electronic commerce opportunity relating to an item corresponding to the bar code. Thus, in this alternative embodiment vendors may register bar codes (e.g., bar code representations) for storage in the commerce opportunity database and, when a user submits a bar code representation for an item, the database is searched for interested vendors. Then, when a portal page is generated and displayed for a user, one or more vendors offering electronic commerce opportunities relating to the item may be identified with the item itself. The electronic commerce opportunities may include a chance to purchase or rent the item or a substitute/alternative. A commerce database may include various information to allow a user to determine whether to avail himself or herself of an opportunity. The database may, for example, include a description of an item or competing/substitute item, comparable prices, etc.

Another database that may be included in this alternative embodiment may be termed a purchase database. Illustratively, a purchase database stores details of purchases made by a user using information (e.g., an electronic commerce opportunity) provided by system 100. The purchase database may store identifiers of all items purchased by a user over a period of time, from a particular vendor, etc. Purchase records may be organized or categorized so that when the user later submits a bar code representation for an item related to a previous purchase to system 100, one or more details of the previous purchase may be presented in association with the item. In addition, when a user links to a particular vendor through system 100, he or she may be presented with a list of other items (or related items) he or she purchased from that vendor and may want to purchase again (e.g., a grocery list).

Thus, a purchase database may allow a portal page to incorporate a tool to identify or organize items a user wishes to purchase or has purchased from one or more vendors. System 100 may collect the information needed to conduct a purchase (e.g., item identifier, quantity, price, method of payment) and submit them to a vendor for a user.

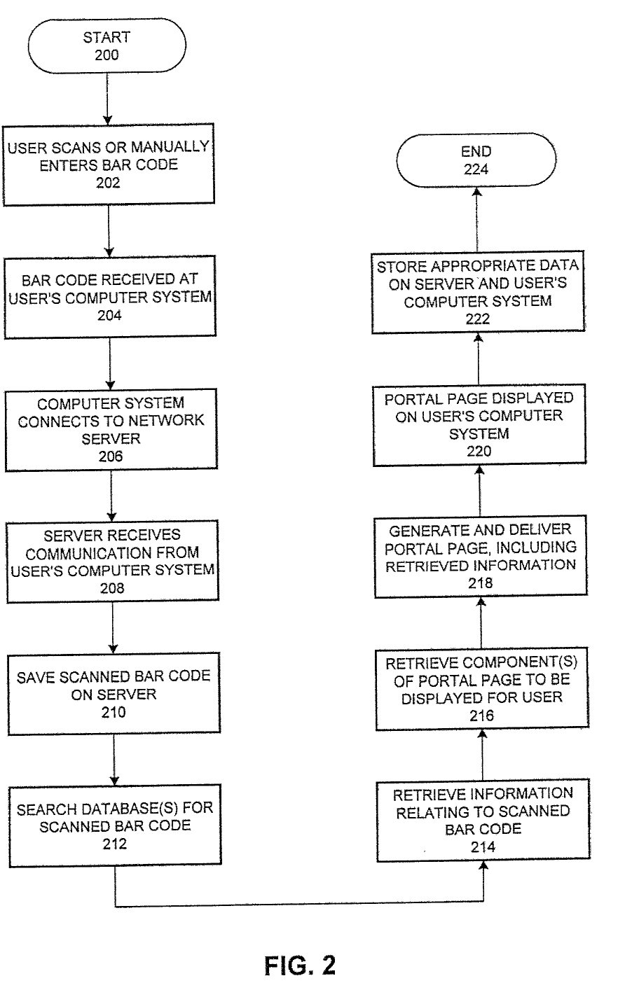

With reference now to FIG. 2, one method of receiving a bar code representation from a user and providing him or her with a portal page including information relevant to an item associated with the bar code is described. Prior to the illustrated method, the user obtains or receives a bar code reader or scanner. As described previously, the bar code scanner may take virtually any form and may communicate with the user's computer system through a wired or unwired (e.g., RF (Radio Frequency)) connection and may form an integral part of the computer (e.g., a hand-held model) or may attach as a peripheral device.

In addition, a program operates on the user's computer system for receiving a scanned bar code from the bar code scanner and for forwarding a digital or other representation of the bar code to system 100. The program may comprise a distinct application or may be linked or embedded in another application (e.g., a web browser, operating system, communications program). In one embodiment of the invention the program may be supplied by the entity that provides the user's bar code scanner. In this embodiment the program may be branded (e.g., customized) to identify the provider (e.g., via a banner, advertisement or other graphic displayed by or as part of the program). The program may also be serialized or incorporate other data to identify the user or the user's computer or scanner. Also in this embodiment, the program may be automatically launched when the user scans a bar code or the user may launch the program prior to scanning a first bar code.

In FIG. 2, state 200 is a start state, which illustratively corresponds to the initiation of execution of the program for receiving bar code representations from a bar code scanner.

In state 202, the user scans a bar code or manually enters the numeric, alphabetic, alphanumeric or other human-readable data that may accompany the bar code. For example, each UPC (Universal Product Code) includes the numeric representation of its bar code, which may be entered manually if the bar code scanner is inoperable or the code itself is illegible or otherwise not scannable.

The bar code scanned by the user in state 202 may be one- or multi-dimensional and may adhere to any public domain or proprietary format. Among the many types of bar codes that may be accepted by system 100 are UPC, Code 3 of 9, POSTNET, Code 128, EAN (European Article Numbering), JAN (Japanese Article Numbering), etc. The amount of information that may be provided to a user for a specific bar code may, however, depend upon whether the type of bar code is in the public domain or is proprietary. In particular, system 100 may be configured to identify a web site or page for each product or item that is associated with a public domain bar code or a bar code generated by system 100. For proprietary codes other than those generated by system 100, however, the amount of information provided by system 100 may depend upon whether the owner of the bar code registered it with the system. Likewise, for each public domain bar code a manufacturer or producer corresponding to a bar code (e.g., the manufacturer corresponding to the 5-digit manufacturer number of a UPC) may supply system 100 with varying levels of information that it desires to be associated with an item or product.

In state 204, a representation of the scanned bar code is received at the user's computer system (from the bar code scanner or, manually, from the user). In one embodiment of the invention the bar code representation is transmitted from the bar code scanner as, or shortly after, the code is scanned. In another embodiment of the invention the bar code scanner may store one or more bar code representations for later transmission to the computer system. The bar code representation may be received at the computer system via electrical, optical, radio frequency or other signals. Along with the bar code representation, when the bar code is scanned using a bar code scanner (e.g., as opposed to when a user manually enters the bar code), the bar code scanner may transmit to the user's computer some data or information (e.g., a serial number) that may be used to identify the provider of the bar code scanner. Alternatively, an identifier of the provider of the bar code scanner may be built-in to the bar code program.

In state 206, the user's computer system connects to system 100. In particular, the computer system may establish a connection, secure or unsecure, to a server configured to establish connections with users. For example, server 102 in FIG. 1 may be configured to establish connections with user computers via the Internet, point-to-point links or other means. In an alternative embodiment of the invention, the user's computer system may be connected to system 100 before the user scans the bar code.

In state 208, system 100 (e.g., server 102) receives a communication from the user's computer. A number of things or pieces of data may be transmitted as part of this communication. In a present embodiment of the invention this communication may comprise an identity of the user (e.g., user or account name, email address, mailing address), an identity of the provider of the bar code scanner that scanned the bar code and a suitable (e.g., digital) representation of the bar code (e.g., the representation received by the user's computer system from the bar code scanner).

In state 210, one or more pieces of data from this communication are saved at system 100, perhaps in a user database. In particular, the bar code representation is stored 10 along with an identifier of the user.

In state 212, system 100 (e.g., a bar code database) is searched for the bar code representation received from the user. If the bar code is found, the information associated with that bar code (e.g., a URL, product description) is then retrieved in state 214. This information will be displayed for the user as part of a portal page dynamically generated by system 100. As discussed in more detail below, the portal page that is displayed for the user may be tailored or customized for the provider of the user's bar code scanner. Illustratively, if the bar code is not found in system 100, default information for the bar code may be retrieved. For example, if the bar code is a UPC symbol, then even though the bar code has not been registered with the system, the system may have suitable information (e.g., a URL) for the manufacturer/provider associated with the code.

In state 216, one or more appropriate components (e.g., advertisements, banners, URLs, graphics, animations) are retrieved for use in generating a portal page for the user. As described in conjunction with FIG. 1, these components may be stored in one or more databases. In one embodiment of the invention each provider of bar code scanners used to read bar codes for submission to system 100 may provide a set of components to system 100. This set of components allows system 100 to construct a portal page appropriate for the scanner provider.

In state 218, system 100 transmits the components of a suitable portal page to the user's computer system, along with any information retrieved that corresponds to the bar code the user scanned. Various formats and protocols exist for transmitting these components from a server to a computer system and one skilled in the art will appreciate that any suitable method of delivery may be applied.

In state 220 the portal page is displayed on the user's computer system (e.g., monitor, LCD or LED display). In this initial page, links may be embedded to direct the user's computer system (e.g., via a web browser) to another network location (e.g., via a URL) or to a follow-on page containing additional information relevant to one or more items associated with the bar code the user scanned. Once the portal page with its various graphics, advertisements, links, and other data is displayed, the user may navigate at will to view information concerning an item, investigate or conduct an electronic commerce opportunity, etc.

In state 222 in this embodiment of the invention, information concerning the user's activity is saved on system 100 and, possibly, his or her computer system. In particular, data concerning the bar codes the user scanned, any items the user was interested in, an electronic transaction the user conducted through system 100, preferences that the user expressed concerning the manner or format in which information is displayed, etc., may be saved. In one embodiment of the invention system 100 accumulates the user's bar code representations over time so that each time he or she connects to system 100 he or she may view all or a subset of the items the user previously expressed an interest in. The user may selectively remove items and bar code representations from those that are to be displayed.

The illustrated embodiment of the invention ends with state 224.

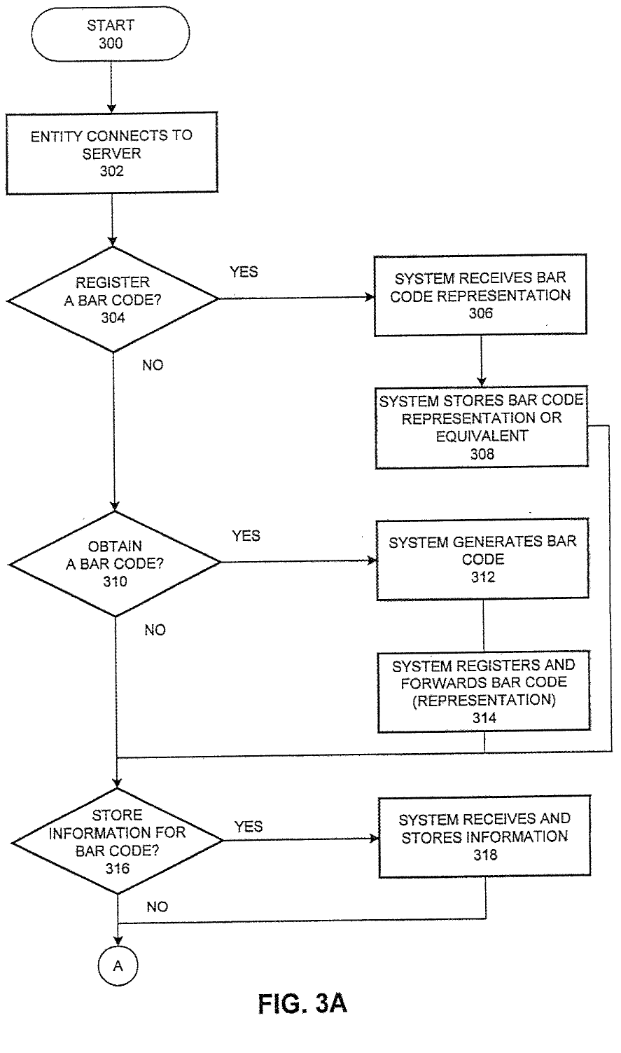

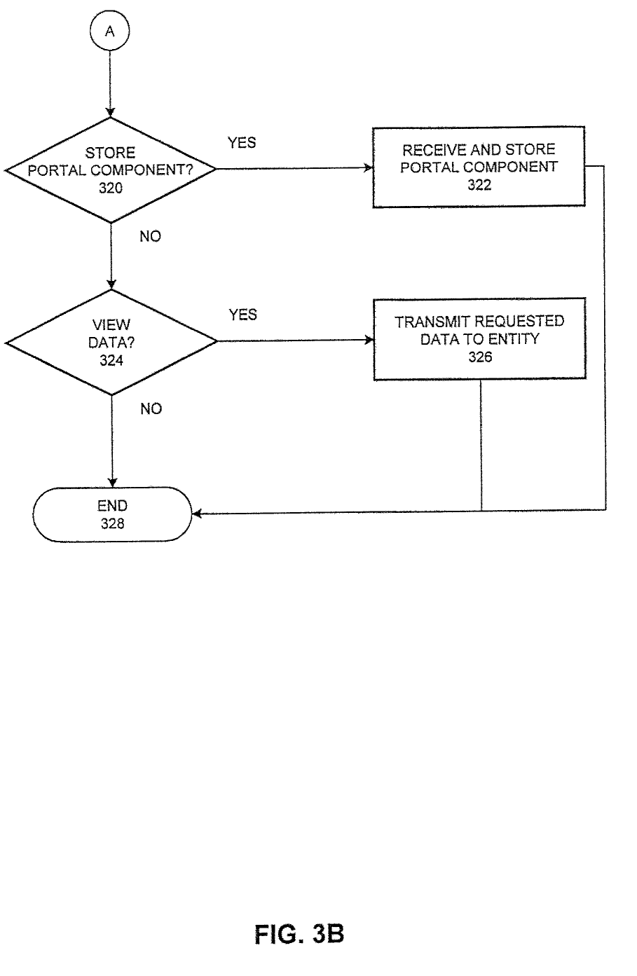

FIG. 3 depicts an illustrative method by which a producer, manufacturer or other entity (e.g., a vendor) interacts with system 100 to perform a variety of actions. For example, the illustrated method may be used to register a bar code with system 100 or to obtain a bar code generated by the system. The illustrated method may also be used to supply system 100 with relevant information concerning an item associated with the bar code (e.g., URL, product description, electronic commerce opportunity, advertisement) or a component to be included in a portal page. The more information submitted to system 100 concerning an item or produce that corresponds to a bar code, the more information that can be provided to a user.

In FIG. 3, state 300 is a start state. In state 302, an entity (e.g., manufacturer, vendor, producer) connects to system 100. During the connection process, the entity is identified to system 100, possibly by an entity or account name. The entity may connect to the system from a computer system such as producer computer system 154 in FIG. 1. The computer system employed by the entity may connect to system 100 via a network such as the Internet, a point-to-point link or other suitable means. Illustratively, the entity's computer system is equipped to scan and/or print bar codes and to store and transmit whatever information the entity wishes to provide to system 100. Within system 100, entity computer systems connecting for the purpose of registering/obtaining a bar code or to provide relevant information may connect to a different server than the server to which users connect. In particular, an administrative server may handle communications with the entity computer system. The connection between the entity and system 100 may be secure or unsecure.

In state 304, it is determined whether the entity wishes to register a bar code. If so, the illustrated method continues at state 306, otherwise the procedure continues at state 310. For purposes of determining an entity's desired action, system 100 may offer the entity a menu of options (e.g., register a bar code, obtain a bar code, store a portal page component, store an advertisement). A page of a World Wide Web site operated for system 100 may include these options plus others-such as reviewing the information, advertisements, portal page components, or any other material that an entity stored previously.

In state 306 the entity computer system forwards a bar code, or a digital or other representation of a bar code, that the entity wishes to register. The bar code may be of a public domain type (e.g., UPC, Code 3 of 9) or may be proprietary. In particular, after an entity registers or obtains a bar code from system 100 (as described below), the entity may wish to change the bar code's association from one item or set of items to another.

The bar code to be registered may have been stored on the entity computer system (e.g., the computer system may store all of the entity's bar codes) or the bar code may be scanned just prior to forwarding its representation to system 100. Alternatively, the bar code may be provided to system 100 in hard-copy form, in which case it would be scanned by the system.

In state 308 the bar code representation received from the entity is stored in system 100 (e.g., in a bar code database). In one embodiment of the invention bar codes are stored in different databases (possibly with different database servers) or different database tables depending upon the type of bar code. Thus, one database would store UPC bar codes, another database would store Code 3 of 9 codes, another would store bar codes generated by system 100, etc. In an alternative embodiment of the invention, however, two or more types of bar codes are stored in a single database. For example, one database or set of databases may store one-dimensional bar codes, another may store two-dimensional codes, etc. In yet another embodiment, multiple types of bar codes may be stored in one database, but in separate tables or other database structures.

The entity may register a bar code for a limited or unlimited certain period of time. Illustratively, if only a limited registration is selected for a bar code then system 100 will cease distributing the relevant information for that bar code to users after its registration expires. After state 308, the illustrated procedure continues at state 316.

In state 310, system 100 determines whether the entity wishes to obtain a unique bar code, generated by system 100. If not, the illustrated procedure continues at state 316.

In state 312, system 100 generates a unique bar code (illustratively, using a proprietary design or format) in response to the entity's request and transmits it to the entity. The entity may be queried as to a size (e.g., length, width, height), type (e.g., onedimensional, two-dimensional, RF (radio frequency)), shape (e.g., rectangular, oval, custom) and other features of the desired bar code. In addition, system 100 may offer a number of formats or types from which the entity may choose. The entity may purchase or lease exclusive or limited use of the bar code (e.g., limited to a certain period of time).

In a present embodiment of the invention, in state 314 the generated bar code is automatically registered for the entity (e.g., stored in an appropriate database). The entity may also identify a set of one or more items or products to be associated with the bar code. The new bar code is provided to the entity in the same form in which it accepts bar codes (e.g., for registration) and/or it may provide a variety of choices (e.g., PDF (Portable Document Format), TIFF (Tagged Image File Format), facsimile). After state 14, the illustrated procedure continues at state 316.

In state 316, the system determines whether the entity wishes to identify any information to be associated with a bar code. As already discussed, such information may include a URL, an advertisement, an electronic commerce opportunity, a product summary, description or review, etc. Note that the entity may be taken to this state immediately after registering or obtaining a new bar code. If the entity is not providing or updating information for a bar code or corresponding item, the illustrated procedure continues at state 320.

In state 318, the entity's information is received at system 100 (e.g., at an administrative or database server). The format in which the information is received may depend upon the type of information and the method of communication between the entity and system 100. In general, however, the information may be received in any suitable form electronically or via hard-copy, as a binary or text file, as a graphical image, or in a format such as HTML (Hyper Text Markup Language), XML (Extensible Markup Language), VDML (Visual Data Markup Language) or VRML (Virtual Reality Modeling Language). One skilled in the art will appreciate that a number of different formats for submitting information to system 100 are suitable. The illustrated procedure then continues at state 320.

In state 320, an entity may choose to store or update a component of a portal page. As discussed previously, an initial or portal page displayed for a user in response to receipt of a scanned bar code may be tailored to a particular entity such as the provider of the user's bar code scanner. Entities for which portal pages are tailored may, therefore, submit and update components to system 100 for use in generating a portal page. As one skilled in the art will recognize, a portal or web page may include many types of objects, including textual, graphical, audio, etc. Access to state 320 may thus be restricted to entities meeting specified criteria (e.g., those that have an account with system 100, provide bar code scanners to users, or otherwise arrange with an operator of the system). Various security strategies are contemplated for restricting the actions of entities and/or users when connected to system 100 (e.g., encryption, passwords).

In state 322, system 100 receives a new or updated portal page component from the entity. The component is then stored appropriately (e.g., in a database with other components associated with the entity). A number of alternative components may be stored such that when a portal page is to be generated, a random or fixed algorithm may be followed so that not all of the portal pages for a given bar code scanner are identical. In other words, although all users that received a bar code scanner from a certain provider may receive a portal page tailored to that provider, the portal pages may or may not be identical. Some may have different banners, color schemes, advertisements, etc.

In state 324, the entity may choose to view a bar code, information concerning a bar code (or corresponding item) or a portal page component previously stored on system 100. This option allows the entity to ensure that the correct data is available for display to users. If the entity does not wish to view any data, the illustrated procedure ends at state 328.

In state 326, system 100 provides the entity with whatever type of data it wishes to view (e.g., bar code, URL, advertisement, portal page component). The system may, for example, generate and transmit to the entity a sample portal page or an actual portal page that had been provided to one or more users.

After state 326, the illustrated procedure ends with state 328. In one alternative embodiment of the invention, the illustrated procedure is recursive, so that an entity may perform several repetitive or non-repetitive actions during a single connection.

In one embodiment of the invention, business entities (e.g., vendors, manufacturers) may have additional options for interacting with system 100. In particular, an entity may receive statistics concerning how many users submitted a particular bar code or bar code representation to the system, how many of a certain bar code scanner provider's portal pages were generated and transmitted to users, the number of users who have connected to the system for any reason, etc. An entity may also have an option of purchasing or licensing additional use of the system (e.g., to have an advertisement provided to another X number of users).

The following sections will set forth several preferred embodiments of the present invention.

Consumer/User

Anonymity

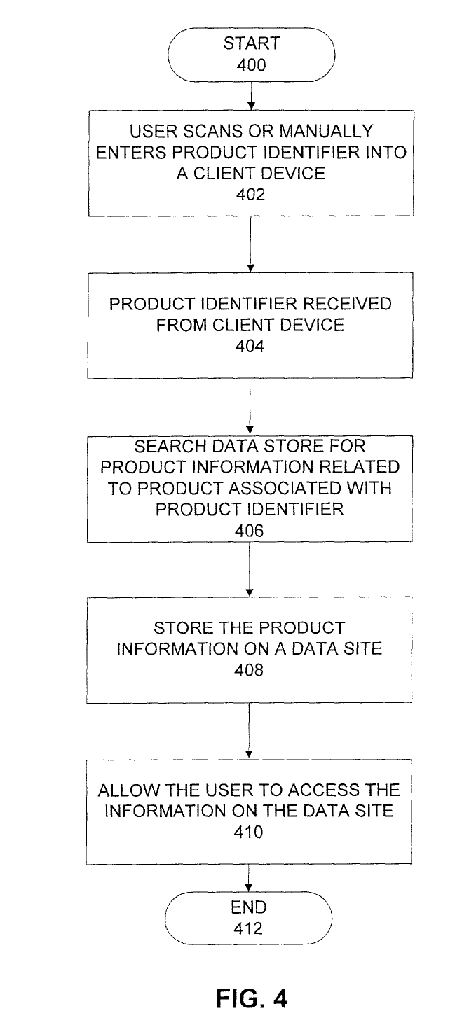

FIG. 4 depicts a process for providing product information to a user while maintaining the anonymity of the user. The process starts at 400. In operation 402, the user either scans or manually enters a product identifier that is associated with a particular product into a client device. (See also operation 202 of FIG. 2.) The product identifier is received from the user's client device in operation 404. Exemplary client devices include a personal computer; a scanner; a portable computing device such as a laptop computer, PDA, etc.; a wireless or hard lined telephone; a pager; or any other device capable of transmitting such data

With continued reference to FIG. 4, a search is made of a data store in operation 406 for matching the product identifier with information about the product. In operation 408, the product information is stored on a network data site. In operation 410, the user is allowed to access the product information on the network data site using a user identifier that is (or has been) obtained anonymously. In other words, the user is not required to enter any personal information (name, address, phone number, etc.) to obtain the user identifier. The user identifier can be a login name with or without an associated password, for example. The process ends at 412.

In one embodiment of the present invention, the product identifier is a representation of a bar code associated with the product. In another embodiment of the present invention, the product information is stored on a web page of the network data site. The web page is associated with the user identifier. This is preferably a private web page, referred to above as a portal page, stored on the network data site and only accessible by the particular user, but can also be one available to a group of users. Preferably, the product information includes at least one of a type of product, information about a manufacturer of the product, a link to a manufacturer of the product, information about a vendor of the product, a link to a vendor of the product, a promotional offer for the product such as a rebate, a sale offer for the product, and/or a discount offer for the product.

According to a preferred embodiment, the system of the present invention doesn't require any personal information for access to the product information, so there is no way anyone can identify the user. Any special offers and promotions found for the user are triggered only by the user's interest in specific products. By design, no one can connect that interest back to the user. For example, product information, advertising, and/or content that may be of interest to the user can be selected based on the product identifier or a use history (navigation history, transaction history, etc.) is stored on the network data site for output to the user with the product information.

Where the person or entity providing services relating to the present invention also provide the client device, any information provided by the user—name, address, and credit card information—is kept separately for a limited time in case the user returns the device for a refund. It is never connected to the user name, or shared with anyone else.

Profiles of users' shopping habits and interests can be compiled in order to negotiate special offers and promotions. However, it is impossible to connect that information to any individual user.

A user's zip code can be requested and received from the user. The zip code can be used to determine which retail stores are close to the user. A user's e-mail can also be maintained so password information can be sent to the user if the user forgets it, as well as to alert the user to special savings if he or she so chooses. This can be made strictly optional, and would not be shared with anyone else.

From time to time, the entity or person managing operation of the present invention may ask the user simple marketing-related questions like what kind of car the user drives or the user's age or salary range. This information is bundled with that from other members to create user profiles. The user profile information is used to negotiate special offers from manufacturers or retailers.

The present invention acts as a matchmaker, not a merchant. The user is presented with a selection of retailers, both on-land and online. Should the user decide to purchase something online, the present invention will provide a link to that retailer's site. The user then decides how much—or how little—he or she wishes to share with the retailer.

The user's personal site (portal page) is password protected. No one else can access it.

Any information the present invention finds for the user comes back to the user at that site, not the user's e-mail, unless the user requests it. Thus the present invention also serves as a buffer against clutter and unwanted email on the Internet.

In the following discussion, the term “subscriber” refers merely to a user who in some sense is known to the system of the present invention. For example, the subscriber may have a personal identifier (user name), but the user's true identity is not known to the system. As used in the description herein, the terms user and subscriber will be used interchangeably, as all embodiments of the present invention can be applied to users and subscribers.

In order to provide services, the present invention may or may not require collection of two types of information from subscribers and visitors: personally identifiable information and aggregated information. The primary goal in collecting information from a user is to provide a smooth, efficient and customized experience while using the services.

When a user registers and uses services provided by the present invention, personal identifying information such as a name, billing & shipping address, e-mail address, telephone number, credit card number and expiration date and other demographic information such as gender, age, income level and other information that a user voluntarily provides in response to feedback forms and surveys (hereinafter referred to as “personal identifying information”) is collected.

Non-personal and aggregated information refers to information that cannot be traced back to a specific individual. The present invention automatically gathers certain information about a user based upon his or her activity on the Site or the way the user uses services. This information may include a Web site's Uniform Resource Locator (“URL”) that the user just came from, which URL the user goes to next, what browser the user is using, access time(s), page views, and the user's Internet Protocol address (“IP Address”). This information is preferably compiled and analyzed on an aggregated basis.

According to an embodiment of the present invention, the personal identifying information is collected and used to provide the user with more relevant services, online shopping and third party offers through a web site. To accomplish this, research is performed on the demographic information collected. This research is compiled, analyzed and used to better serve the user, advertisers and business partners. The information is also used to display and deliver advertisements and content that may be of interest to subscribers as well as promotions, sales or discounts. This information may also be provided in aggregate form to advertisers and partners. In particular, the information provide by the user is utilized as described below.

Personal identifying information can be used to confirm or clarify submitted information and to provide subscribers with updated information about services. Demographic information is used to tailor a subscribers' experience of the service, such as by displaying advertisements and content that might be of interest to the subscriber. No personal identifying information about any subscriber is disclosed to a third party unless the subscriber consents to the disclosure, or except as may be required by law, governmental authority or to cooperate with law enforcement authorities. Information in aggregate form may be shared with advertisers and/or business partners so that they can target advertisements to groups of subscribers.

Contact information and third party data is used to respond to user inquiries, and to enable third-party partners to provide information that the user has contacted them.

Subscribers may elect to receive e-mails regarding promotions, specials, discounts or sales for products and services of advertisers or business partners. If a subscriber elects to receive e-mails, the user's contact or other personal identifying information will not be shared with any third parties that offer such promotions, specials, discounts or sales. All e-mails regarding such promotions, sales, etc. shall originate from a system of the present invention.

To further protect a user's personal information, security systems can be employed to protect the information received from subscribers, such as SSL (Secured Socket Layer) technology and firewalls. In addition, the information in a subscriber's Personal Profile is password-protected so that only the subscriber may access or change the information. Preferably, the user is never asked to divulge his or her password in written or electronic communications.

Cookies are small data text files that are sent from a server computer to the user's computer during a browsing session. The cookies are typically stored on the user's computer hard drive and are used by a Web site to simulate a continuous connection to that site. In order to make a Site more responsive to the needs of its visitors, an embodiment of the present invention uses cookies to assign the user's Internet browser a unique random number, a sort of anonymous user ID that is stored in a file on the user's computer. The site uses cookies for marketing purposes in order to deliver content and advertising specific to the user's interests and demographics. In this way, the site can be tailored to the needs of the user, to deliver a better, more personalized service, and to track the pages on the sites visited by users. This unique identification number automatically identifies the user's browser to computers on the Site whenever the user interacts with the Site.

Portal Page

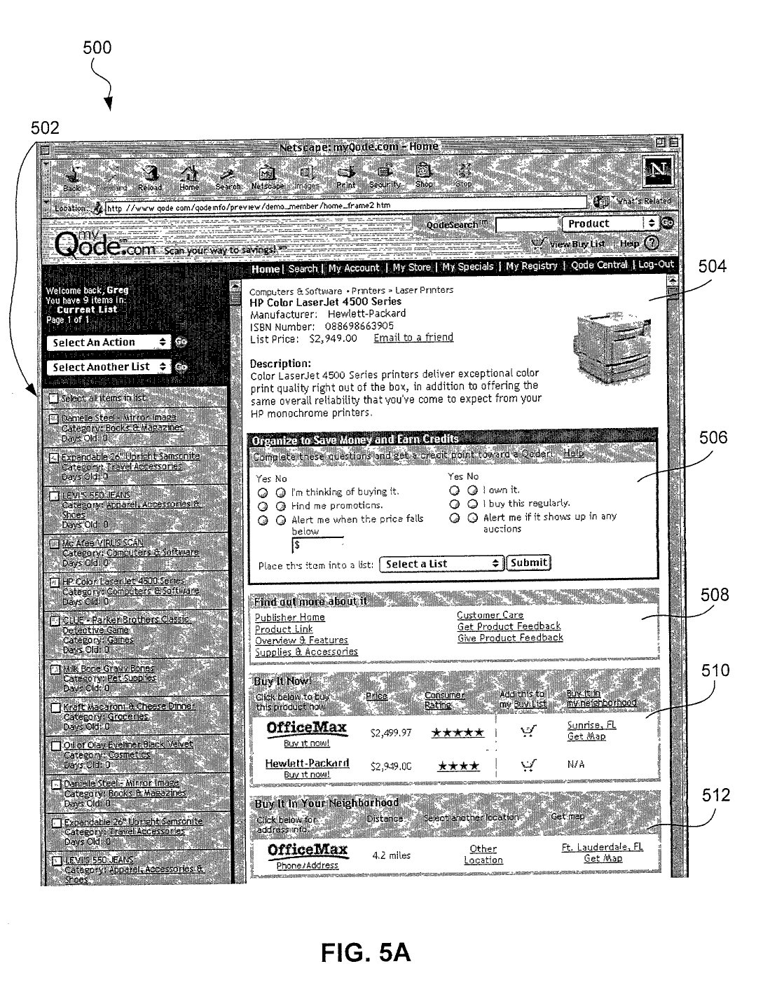

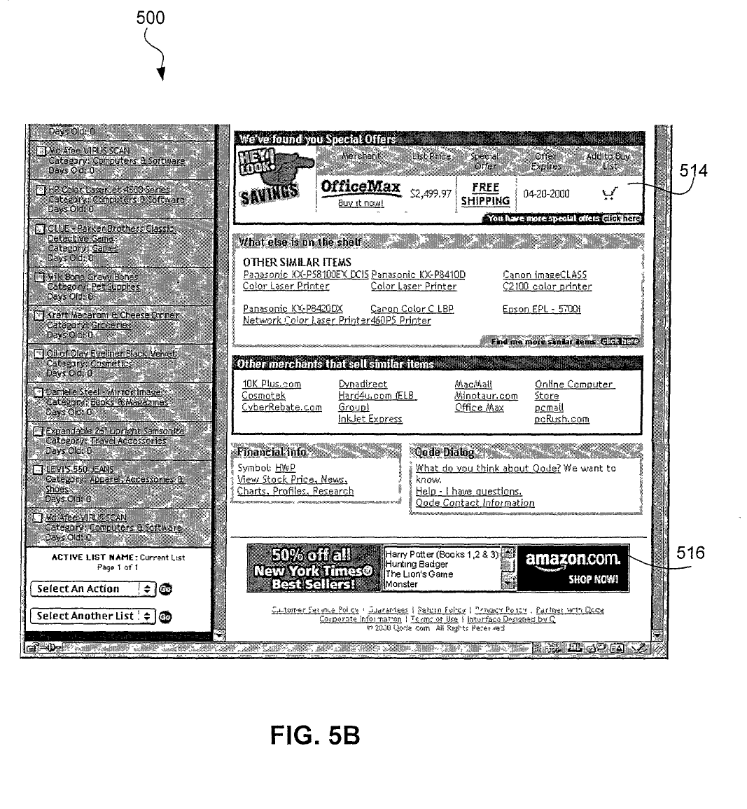

FIGS. 5A and 5B together illustrate an exemplary portal page 500 that can be generated for presenting product and/or promotional information to the user. Note that the layout of the page is not important, and preferably can be tailored by the particular user. As shown, the portal page includes at least one list 502 of product names for which the user has entered bar code information. Each of the product names is linked to more information, which is displayed in an information frame 504. In this example, information about an HP printer is displayed in the information frame upon selection of the product “HP Color LaserJet 4500 Series” from the list.

An input form 506 can be presented to assist the user to quickly obtain the desired information. For example, the user can use this tool to find promotions or sales, to receive feedback from vendors of the product, and to instruct the system to watch for a certain price.

Links 508 to more information are also provided in the information frame. In this example, links to the manufacturer, a features page, etc. are provided. Several vendors of the product are provided in the section 510 entitled “Buy It Now!” The section 512 entitled “Buy It In Your Neighborhood” lists vendors of the product based on geographic location. Preferably, maps and/or directions to the vendors are made available to the user.

A Special Offer section 514 presents special offers such as rebates, vendor programs, etc. Links to other similar items and/or vendors that sell similar items can also be presented. Advertising 516 can also be presented on the portal page.

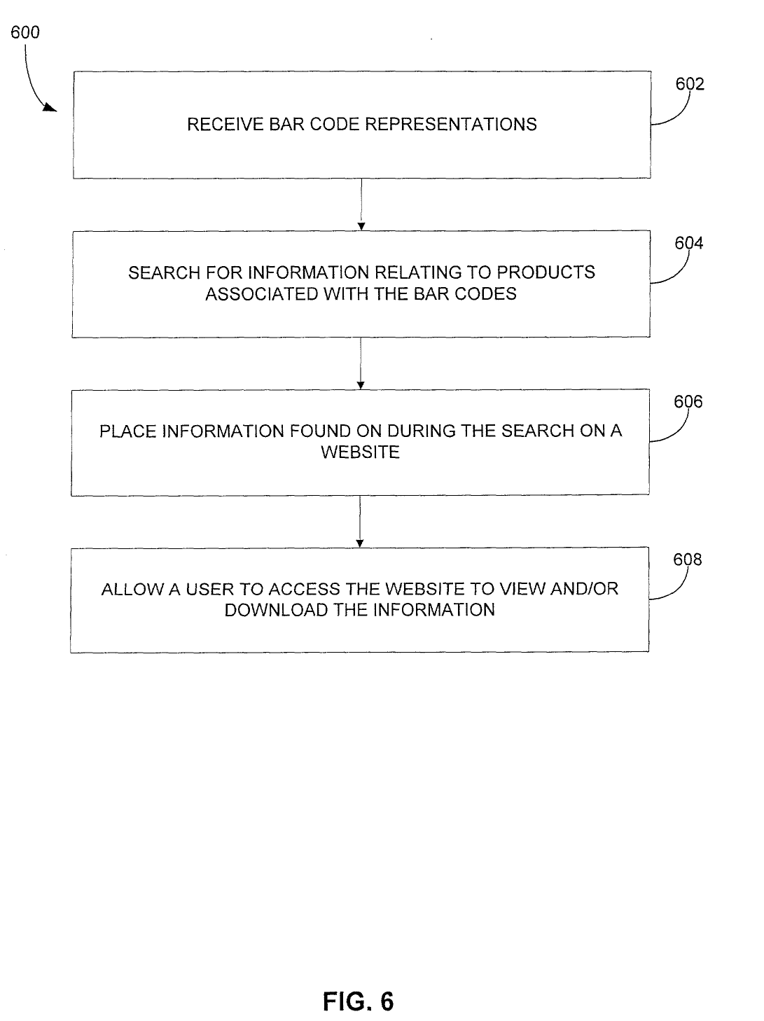

FIG. 6 illustrates a process 600 for generating a website based on input of bar code information. In operation 602, a plurality of representations of bar codes are received from a user utilizing a network such as the Internet. Each representation of a bar code is associated with a particular product. In operation 604, a search is performed to find information relating to the products. Such a search can be performed on the Internet or in local or remote databases. The information found during the search is placed on a website in operation 606. Note that the information can consist of nothing more than links to more detailed information. In operation 608, the user is allowed to access the website to retrieve the information, such as via a portal page.

In one embodiment of the present invention, the product information is stored on a web page of the website. The web page is associated with the user identifier. This is preferably a private web page stored on the website and only accessible by the particular user, but can also be one available to a group of users.

According to another embodiment of the present invention, the product information includes links to at least one of vendors of the products, marketers of the products, and manufacturers of the products. As an option, the product information can include links to content items relating to the products. The links can be to information sites, documents, audio and video clips, etc. As another option, the product information includes promotional offers such as rebates, sales, discounts, etc.

Preferably, a remote shopping list is also generated which can optionally be accessed from a remote device and/or be made available on the portal page. The user can select products for placing on the list as well as enter them by scanning bar codes. Then, when the user goes shopping, the list can be downloaded. The shopping list can also be custom embedded in a vendor's website.

Open Page Upon Docking of Device

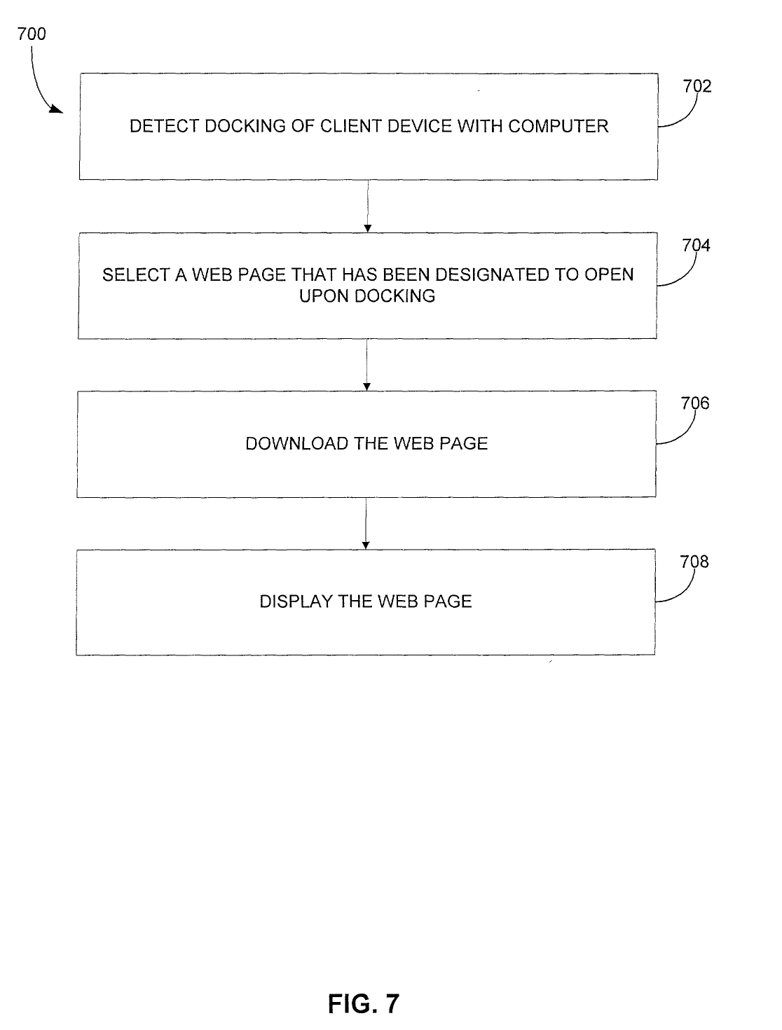

FIG. 7 depicts a process 700 for driving navigation to a particular web site. In operation 702, a docking of a user's client device with a computer is detected. This can include use of a docking station as well as any other type of connection, including cable connections and infrared (IR) connections for example. A web page pre-designated to open upon docking of the client device is selected in operation 704. Such designation information may be stored on the computer or can also be stored on the client device. The pre-designated web page is downloaded in operation 706 utilizing the Internet or other network. The web page is displayed on a display of the computer in operation 708.

In one embodiment of the present invention, the client device is preset prior to sale such as during manufacture to open the pre-designated web site. Alternatively, or additionally, the user can be allowed to set the pre-designated web page.

The client device can be any device, such as a second personal computer, a scanner preferably with a display mechanism, a portable computing device such as a laptop computer, PDA, etc., a wireless or hard wired telephone, a pager, a facsimile machine, etc.

As an option, the web page can present information relating to a use of the client device. For example, if the scanner is used for scanning bar codes for later input, the web page that opens can be one which displays information about the products of the input bar code representations.

Product Selection Across Multiple Websites

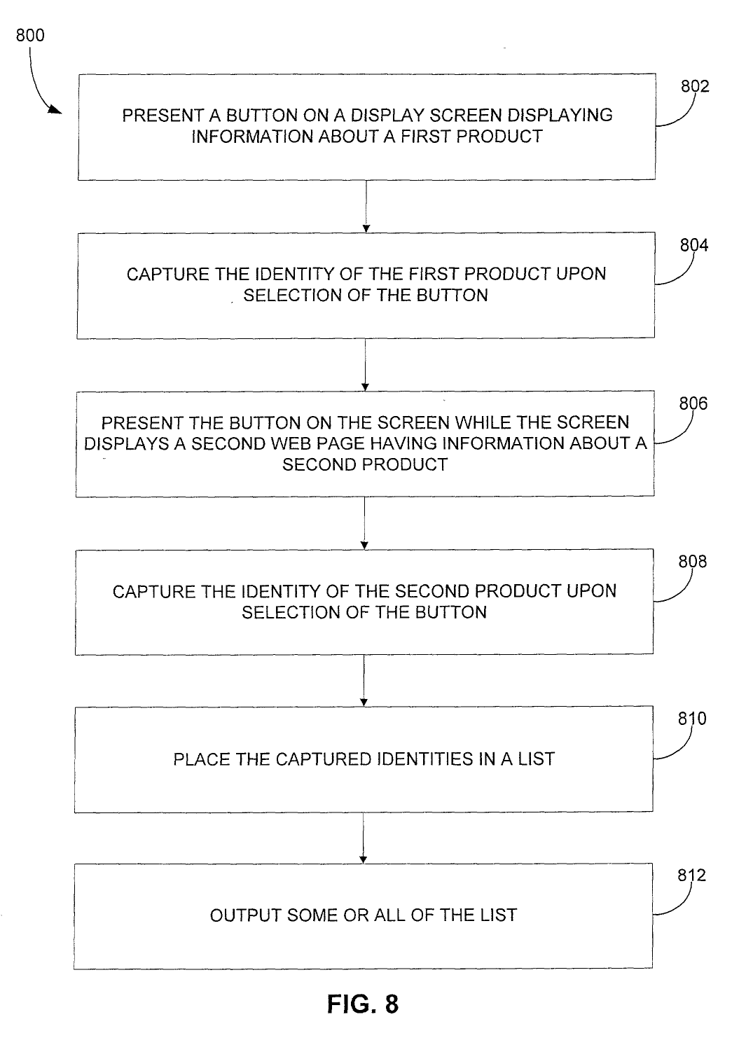

FIG. 8 depicts a process 800 for allowing selection of products while navigating multiple websites. In operation 802, a button is presented on a display screen that is displaying a web page of a first website, where the web page has information about a first product thereon. An identity (i.e., brand name/generic name and/or type) of the first product is captured in operation 804 upon selection of the button. For example, when looking at information about a pain reliever on a website, pressing the button would capture the generic name ibuprofen and/or brand name Advil(t, for example, or at least that the information is about a pain relieving medicine. In operation 806, the button is presented on the display screen upon displaying a web page of a second website, where the web page of the second website has information about a second product thereon. Preferably, the button can “float” on the screen as the user browses, can be made to stay “on top” of the windows being displayed, can be hidden, can be presented only upon determining that the page being displayed has product information thereon, etc. An identity of the second product is captured in operation 808 upon selection of the button. The identities of the products are placed in a list in operation 810. In operation 812, at least a portion of the list is output to a user or to a data store for later retrieval and/or viewing.

In one embodiment of the present invention, identities of alternative (including substitute) products are also output. Preferably, the list is output to a portable client device of the user such as a wireless telephone, personal computing device (PDA), pager, laptop computer, etc.

In another embodiment of the present invention, information about a vendor of the products listed on the portion of the list can be output. Such information about the vendor can include a store name and location, price, availability, web address, link to website, etc. Preferably, the vendor is selected based on the number of products on the portion of the list that are available from the vendor. In other words, the vendor is selected based on the user's ability to get as great as many of the items on the list at the store/website as possible. The vendor can also be selected based on prices of the products, proximity to the vendor, availability of delivery, whether the products are in stock, wrapping availability, shipping availability, tracking availability, and/or a loyalty program.

Search for Product Information

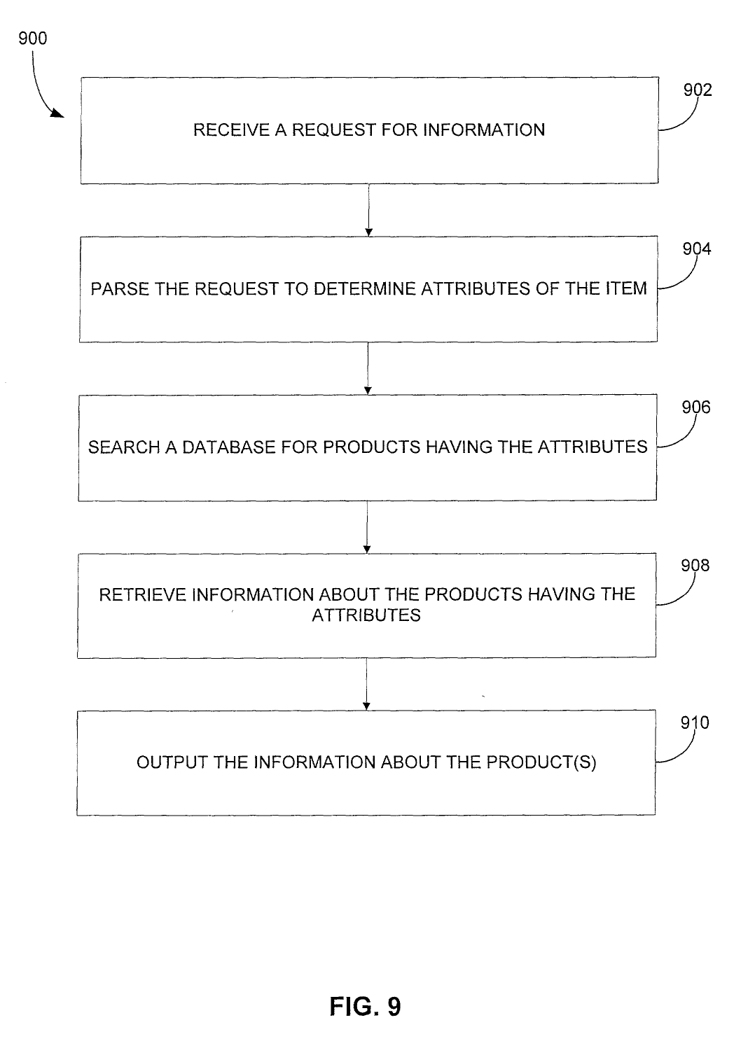

FIG. 9 illustrates a process 900 for matching products to a textual request. Upon receiving a request for information about an item in operation 902, the request is parsed in operation 904 to determine attributes of the item such as functional attributes and/or physical attributes such as weight, size, and features. In operation 906, a search of a database is performed for selecting a plurality of products each having the attributes of the item. The attributes may have been manually entered in the database for each of the products. Information about the products is retrieved and output in operations 908 and 910, respectively.

In one embodiment of the present invention, the plurality of products have been pre-associated based on the attributes. Preferably, the information about the products includes a name of a vendor or vendors of the products, whether the vendor is online or otherwise. Ideally, the criteria for selecting the vendor include a price of the products, proximity to the vendor, availability of delivery, whether the products are in stock, wrapping availability, shipping availability, tracking availability, and/or a loyalty program. A promotional offer may also be output with the information about the products.

In an exemplary embodiment of the present invention, two eCommerce merchants are online selling the same products. Since no barcode has been input by the user, there is no way to easily identify comparable goods. For example, when a user keys in “Sony camcorder,” five models meet the criteria, which may be too many. A matching algorithm of the present invention marries products together and provides products that have attributes that are most similar to the description input by the user. The result is a database that is tuned to the user's requirements. Thus, the present invention narrows the products down to a small set of products. Preferably, the present invention has the capability for automated self-learning such that it knows when two attributes are identified, then comes up with the products that match and the product with all the locations to get the product from (multiple stores/sites, etc.).

Vendor Selection

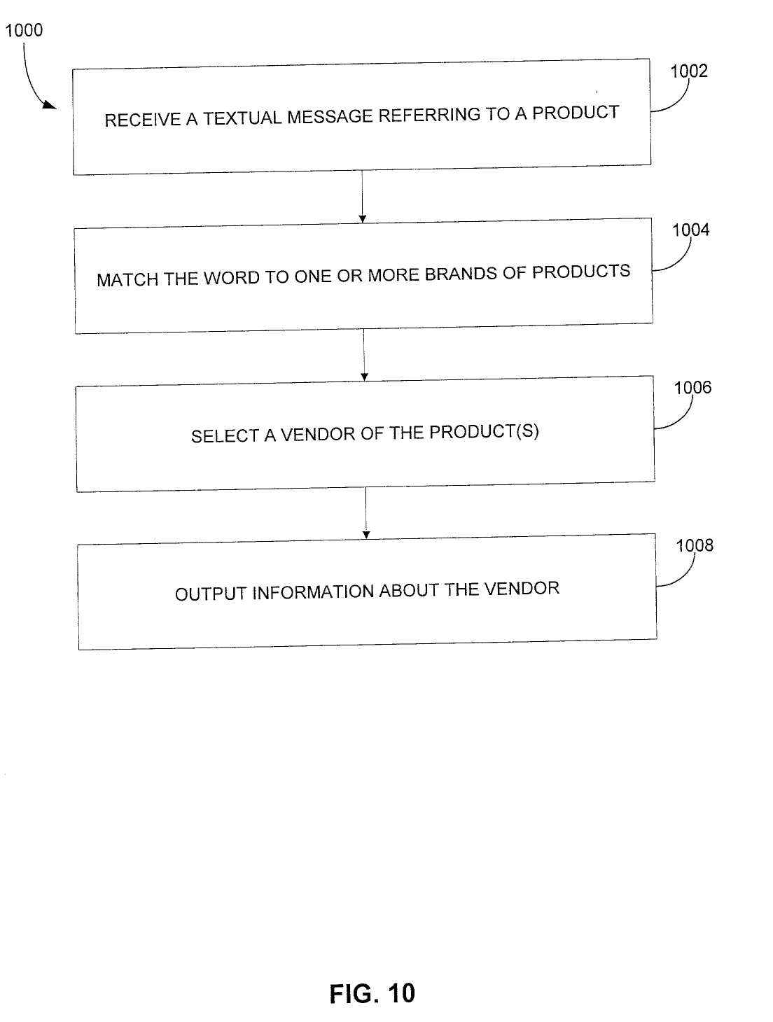

FIG. 10 depicts a process 1000 for selecting a vendor of a product, whether the vendor is on line, has only physical stores, uses mailings, etc. In operation 1002 of the process, a textual message having a word generically referring to a product (or products) is received. For example, the message might say “Pick up an electric razor and some pens on the way to work.” The words “electric razor” and “pens” are recognized by a language recognition program as distinct products. In operation 1004, the word (or words) is matched to one or more brands of product. A vendor of the brand(s) of product is selected in operation 1006. In operation 1008, information about the vendor is output. For example, such information can include a store name and location, price, availability, web address, etc.

In one embodiment of the present invention, the vendor is selected based on the number of brands of products available from the vendor. In other words, the vendor is selected based on the user's ability to get as great a selection of the items on the list as possible. In another embodiment, criteria for selecting the vendor include one or more of: price of the product(s), proximity to the vendor, availability of delivery, whether the products are in stock, wrapping availability, shipping availability, tracking availability, and a loyalty program.

When a vendor is selected based on proximity to the vendor, the present invention preferably outputs maps and/or directions to the vendor's location(s). Store hours can also be included. If the vendor is available online, the present invention preferably provides direct links to the vendor's site.

In an embodiment of the present invention, a determination is made as to the availability of the product at the vendor, as well as a cost of the product charged by the vendor. A summary of the determinations is then output. As an option, a promotional offer can be output with the information about the selected vendor. In a preferred embodiment of the present invention, an order for the product can be placed with the selected vendor for later pick up or delivery.

Preferably, the vendor is selected from a directory of vendors that have paid a fee to be included in the directory. When a prospective customer searches for a product, the paying vendor(s) appear as the retailer(s) that carry the item. Thus, the present invention acts as a matchmaker for directing customers who want a product to the paying vendors.

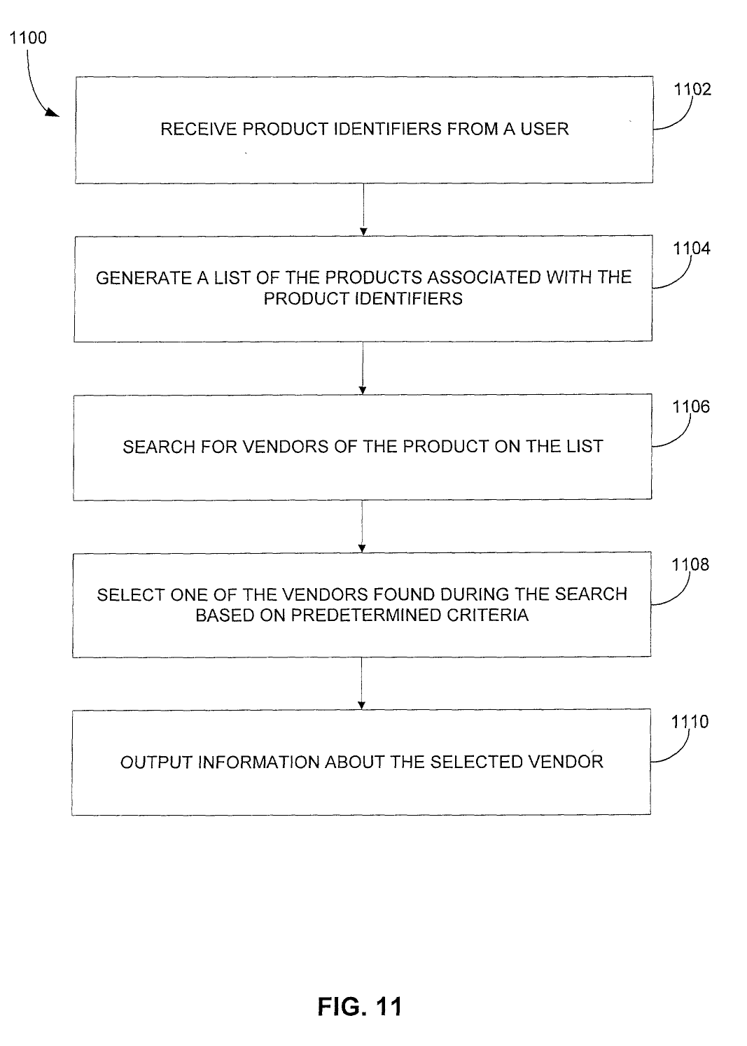

FIG. 11 is a flow diagram of a process 1100 for selecting a vendor based on a list of user-selected products. In operation 1102, a plurality of product identifiers are received from a user. Each product identifier is associated with a particular product. A list of the products is generated in operation 1104. A search is made for vendors of the products on the list in operation 1106. In operation 1108, a vendor (or multiple vendors) of the products found during the search is selected based on predetermined criteria. Information about the selected vendor(s) is output to the user in operation 1110.

In one embodiment of the present invention, the product identifier is a representation of a bar code associated with the product. In another embodiment of the present invention, the vendor is selected based on the number of products on the list available from the vendor. In other words, the vendor is selected based on the user's ability to get as many of the items on the list as possible.

Preferably, the criteria for selecting the vendor includes at least one of price, proximity to the vendor, availability of delivery, whether the products are in stock, wrapping availability, shipping availability, tracking availability, and a loyalty program.

As an option, an availability and price of the products at each of a plurality of vendors are determined summaries are output. Also optionally, a promotional offer can be output with the information about the selected vendor. Preferably, the process is repeated in real time each time a product identifier is received from the user.

Thus the various embodiments of the present invention allows the user to:

1) Locate where to shop (i.e., name and location of a vendor) based on the list.

2) Locate where to shop based on getting as much of the list as possible at one store.

3) Locate where to shop based on the user list and purchase while on the go (mobile or remote data presentation and purchasing).

4) Locate where to shop, shop and have the product(s) delivered to the home.

5) Locate where to shop anywhere in the world based on:

a. Price,

b. Delivery,

c. Availability, and/or

d. Most hits.

Further embodiments of the present invention also provide the following:

1) Alerts delivered in real time to assist shopping (non-real-time or real-time shopping).

2) Alerts based on targeted promotions to attract business from an alerted retailer.

3) Alerts based on physical proximity to the vendor's location.

4) Universal shopping cart-analyze the products and which vendor could provide it and at what prices. The user reviews and picks who to buy from and the options available from the vendor(s) (wrapping, shipping, tracking, loyalty program).

Alert User to Promotional Offer

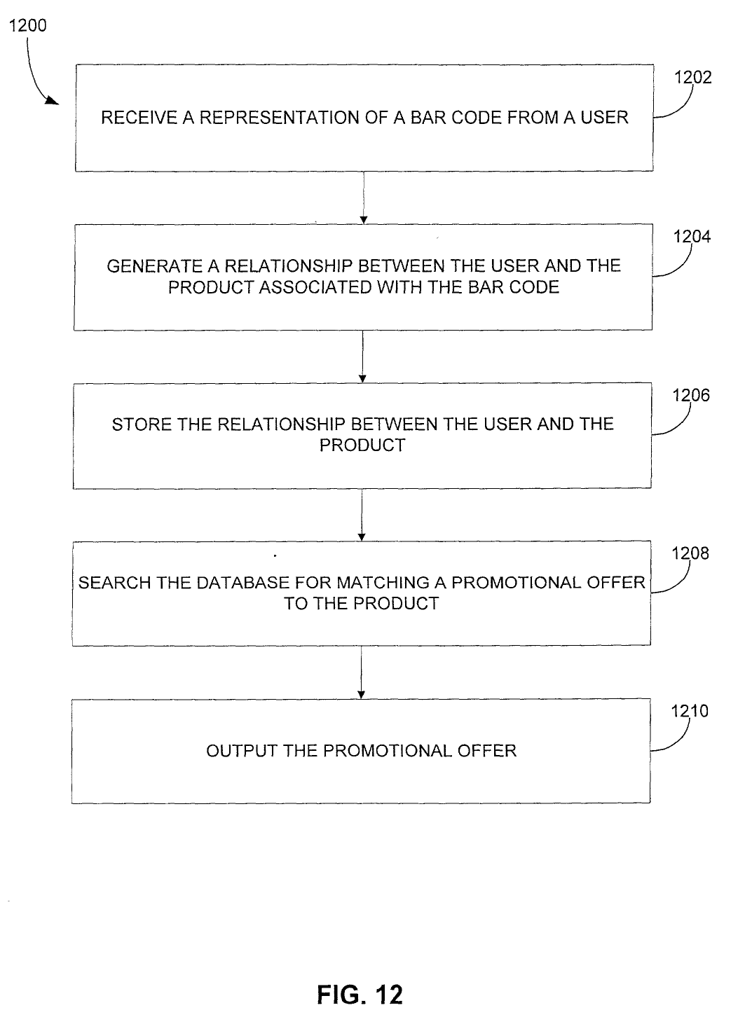

FIG. 12 depicts a process 1200 for alerting a user to a promotional offer for a product. A representation of a bar code is received from a user in operation 1202. The representation of the bar code is associated with a product. A relationship between the user and the product is generated in operation 1204. In operation 1206, the relationship between the user and the product is stored in a database. A search is performed in operation 1208 for matching a promotional offer to the product. Any suitable query language or search engine known in the art can be used to perform the search. In operation 1210, the promotional offer is output to the user based on the relationship of the user with the product. It should be noted that the relationship of the user to the product may represent nothing more than merely an expressed interest in the product, for example.

In one embodiment of the present invention, the promotional offer is selected based on criteria input by the user. Preferably, the criteria includes one or more of: a price of the product, a location of a vendor of the product where the location criterion can be a general geographic area, a date, a time, wrapping of the product, shipment of the product, and ability to pick up the product.

In another embodiment of the present invention, the promotional offer is output to a web page of a network data site. The user accesses the web page for viewing the promotional offer. As an option, content relating to the product is also output to the user. Such content can be product information, advertising, etc.

Preferably, the promotion offer is output to a client device of the user, such as a personal computer; a scanner with a display mechanism; a portable computing device such as a laptop computer, PDA, etc.; a wireless or hard lined telephone; a pager; and a facsimile machine.

Presenting Product Information Based on Navigation

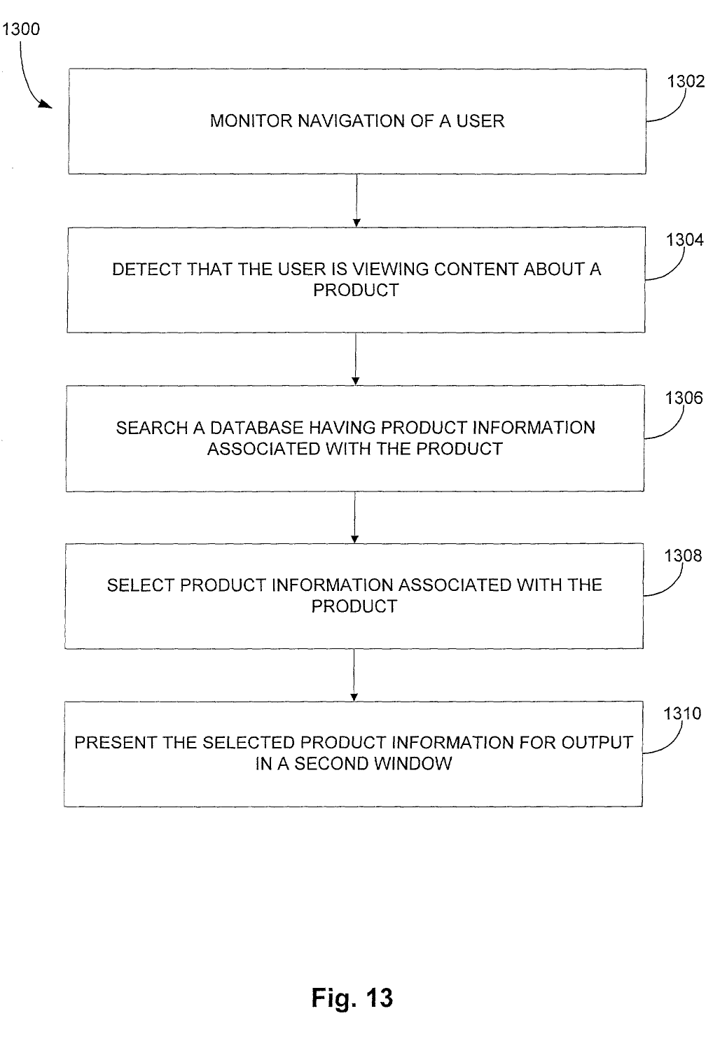

FIG. 13 illustrates a process 1300 for presenting product information. A navigation of a user is monitored in operation 1302. In operation 1304, a detection is made that the user is viewing content about a product. A database having product information associated with the product is searched in operation 1306. Product information associated with the product is selected from the database in operation 1308 based on the search. In operation 1310, the selected product information is presented for output in a second window of a display being viewed by the user.

In one embodiment of the present invention, the associations have been previously created by the user. In another embodiment of the present invention, the selected product information can be an advertisement relating to the product. The selected product information can also be about an alternative (substitute) product. Further, the selected product information can be a promotional offer such as rebates, sales, discounts, etc. relating to the product. The selected product information can also include information about a vendor of the product. Such information about the vendor can include a store name and location, price, availability, web address, link to website, etc. In another embodiment of the present invention, a fee is charged for presentment of the selected product information. The fee can be charged to the user and/or a vendor, manufacturer, etc. of the product.

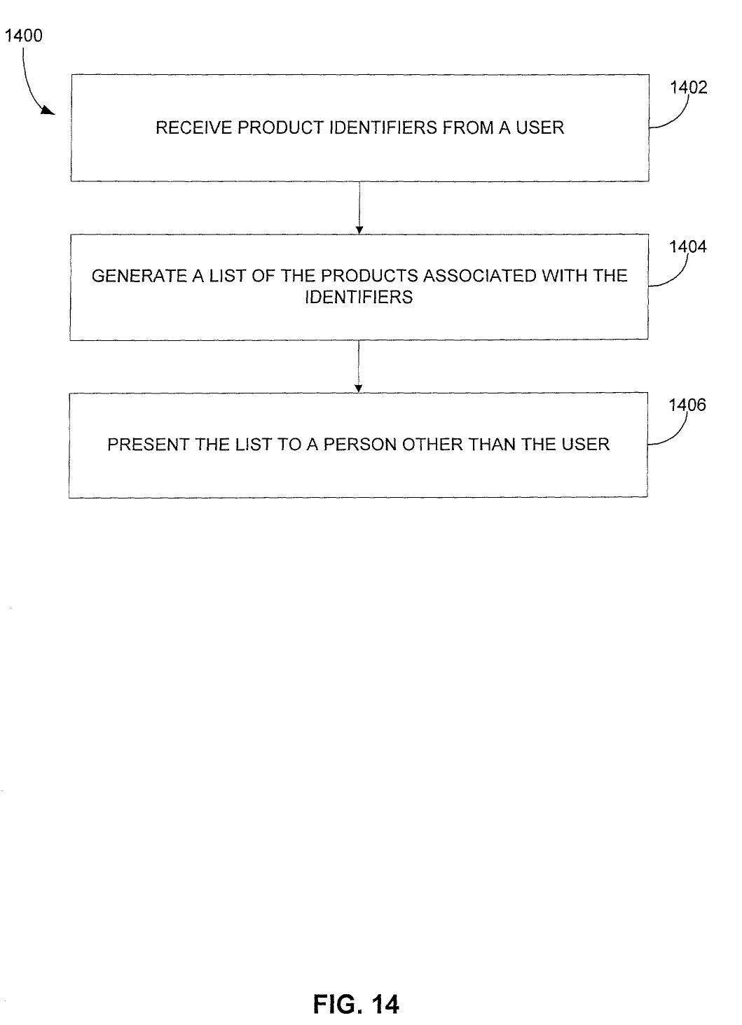

FIG. 14 is a flow diagram depicting a process 1400 for generating a list of desired products for presentment to a person other than the user desiring the products. In operation 1402, a plurality of product identifiers are received from a user utilizing a network such as the Internet. Each product identifier is pre-associated with a particular product. A list of the products is generated in operation 1404 and, in operation 1406, is presented to a person other than the user.

Preferably, the product identifier is a representation of a bar code associated with the product. In an embodiment of the present invention, the user identifies the other person, and an electronic copy of the list is sent to the other person such as via email or by sending a link to website storing the list. As an option, the list can be stored at a network site such as on a web page. The other person then downloads the list from the network site for viewing locally on his or her computer, telephone, PDA, etc. For example, the list can be stored in HTML on a website and sent to the web browser of the other person for display. Preferably, the list of products also includes information about at least one vendor of the products such as store names and locations, prices, availability, web addresses, etc.

Vendor/Manufacturer/Marketer

The following embodiments of the present invention are primarily designed for parties other than end consumers.

Promotional Offers

Embodiments of the present invention allow vendors, manufacturers, marketers, etc. to offer targeted promotions to shoppers who have already expressed an interest in their products. This provides a new and efficient manner to deliver promotions. An additional benefit is a real time indication of consumer product interests.

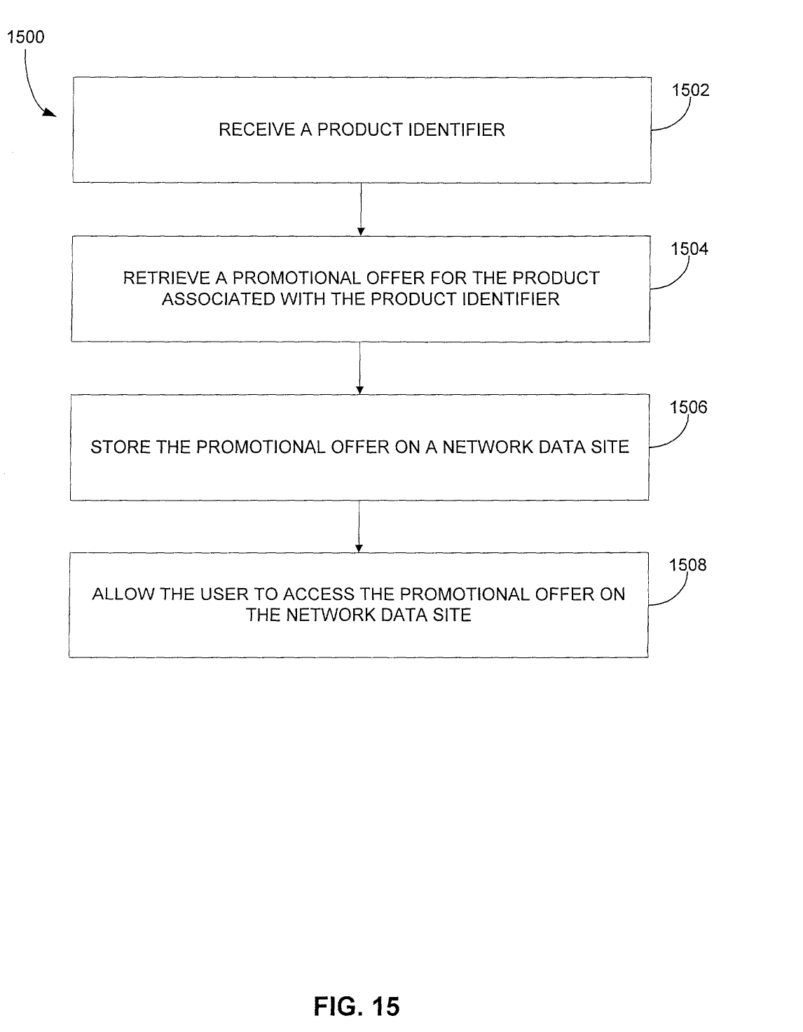

FIG. 15 is a flowchart of a process 1500 for targeting a promotion to a user based on a user-entered product identifier. In operation 1502, a product identifier is received from a client device of a user. The product identifier is associated with a particular product. A promotional offer for the product is received in operation 1504, where the product is associated with the product identifier. Such promotional offers can include a rebate, a sale offer, and a discount offer, for example. The promotional offer is stored on a network data site in operation 1506. In operation 1508, the user is allowed to access the promotional offer on the network data site using a user identifier such as a login name with an associated password.

In one embodiment of the present invention, the product identifier is a representation of a bar code associated with the product. In another embodiment of the present invention, a data store is searched for matching the product identifier with information about the product.

The promotional offer can be received from one or more vendors of the product. Similarly, the promotional offer can be received from one or more manufacturers of the product. In a preferred embodiment, the user is not required to enter any personal information to obtain the user identifier.

Note that the promotion can be made available to the user while maintaining the anonymity of the user by applying the features of the present invention set forth above in the subsection entitled “Anonymity” and with respect to FIG. 4.

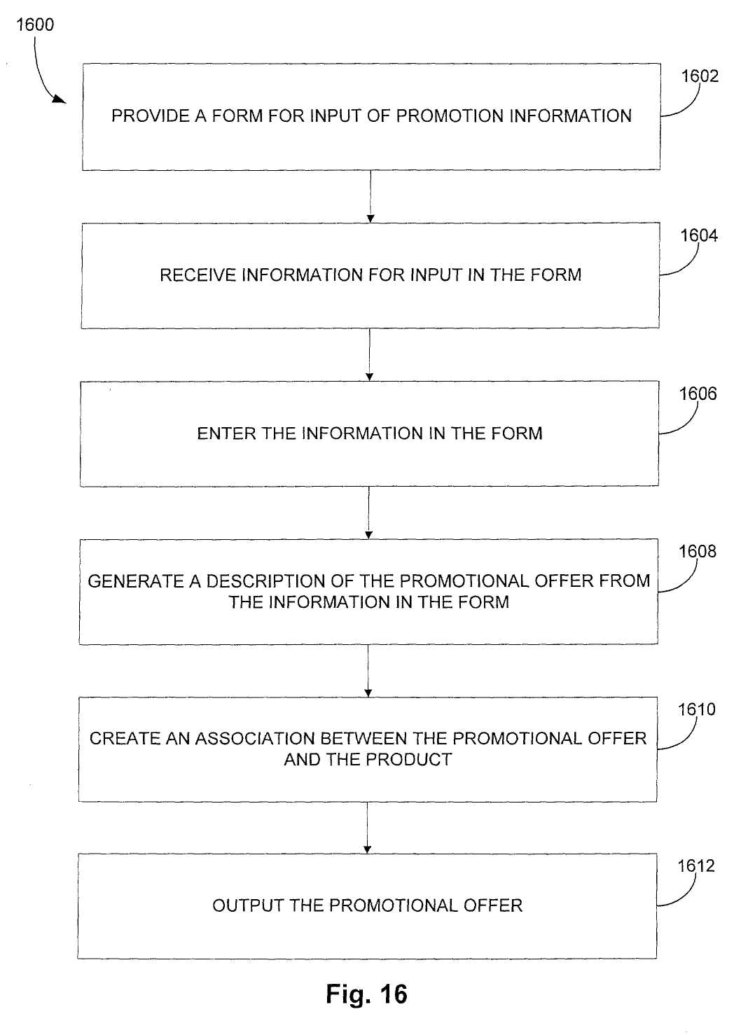

FIG. 16 illustrates a process 1600 for generating a promotional offer for a product. A form is provided in operation 1602. The form has one or more fields, such as a field for entering a product identification associated with the product or service, a promotion field for identifying the promotional offer, a price field for the promotional price, a discount field for the amount of the discount if one is offered, a date field for entering the start date and/or duration that the promotion is available, and/or a field for an identifier of the entity or person offering the promotional offer. Information for entering in the field(s) of the form is received and entered in the field(s) in operations 1604 and 1606, respectively, for completing a sufficient portion of the form. In operation 1608, a description of the promotional offer is generated based on the sufficiently completed form. In operations 1610, the promotional offer is associated with the product and in operation 1612 is output to a user upon receiving a request for information about the product.

Preferably, the process of the present invention is carried out by a facilitating organization. The information for entering in the fields of the form can received from a vendor and/or marketer of the product.

In one embodiment of the present invention, the form is presented on a local data site such as a website, where the information for entering in the fields of the form is received from a third party utilizing a network such as the Internet. Preferably, the product information is stored on a web page associated with the user. In a preferred embodiment, the form is provided as an extranet toolset to vendors and marketers.

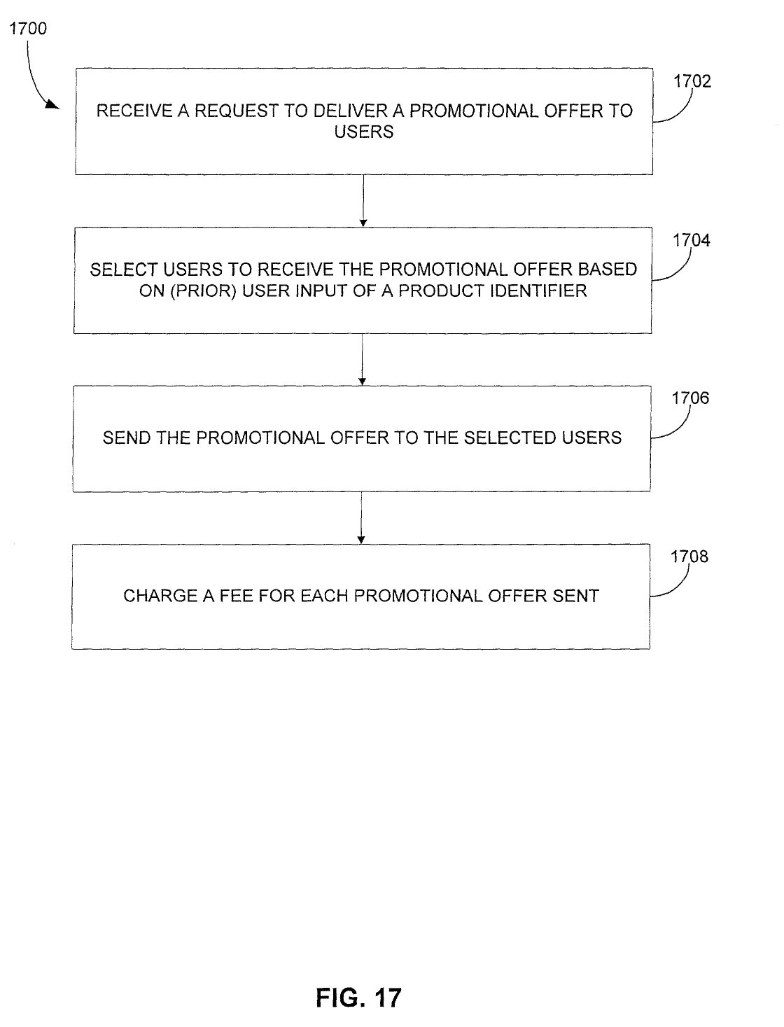

FIG. 17 illustrates a process 1700 for delivering a promotional offer such as a rebate, sale, discount, etc. In operation 1702, a request is received from a product seller for delivery of a promotional offer for a product to a plurality of users. In operation 1704, users are selected to receive the promotional offer based on (previous) input by the users of a product identifier of the product. The promotional offer is sent to the selected users in operation 1706. In operation 1708, a fee is charged for each promotional offer sent. The fee is preferably charged to the product seller, which can be a manufacturer, reseller, marketer, etc.

In one embodiment of the present invention, the product identifier is a representation of a bar code associated with the product. In another embodiment of the present invention, multiple requests for delivery of promotional offers is received from a plurality of sellers of the product, wherein an additional fee is charged for prioritizing the promotional offer one of the sellers. For example, the present invention allows sending of promotions from Company A and Company B for 80 cents per promotion. However, the promotion of Company B would be given priority for the fee of $1 per promotion (20 cent additional fee).

In an embodiment of the present invention, the promotional offer is sent to a client device of at least one of the users. Such a client device can be: a personal computer, a scanner with a display mechanism, a portable computing device such as a laptop computer, PDA, etc., a wireless or hard wired telephone, a pager, and a facsimile machine. As an option, an additional fee can be charged for delivery to certain devices.

For example, $1.20 per promotion can be charged for delivery to the pager (80 cents per promotion sent plus a 40 cent additional fee), while $1.50 is charged for each telephone delivery (a 70 cent additional fee).

In yet another embodiment of the present invention, the promotional offer is sent to each of the users via a web page personalized for the particular user. Preferably, the promotional offer includes information about a vendor of the product such as store name and location, web address, availability of the product, etc. Also note that the vendor of the product may or may not be the entity originally requesting that the promotional offers be sent.

In a further embodiment of the present invention, a commission is collected for a sale of the product to one of the users. The commission can be percentage based as well as a set amount.

Targeting Sales Information

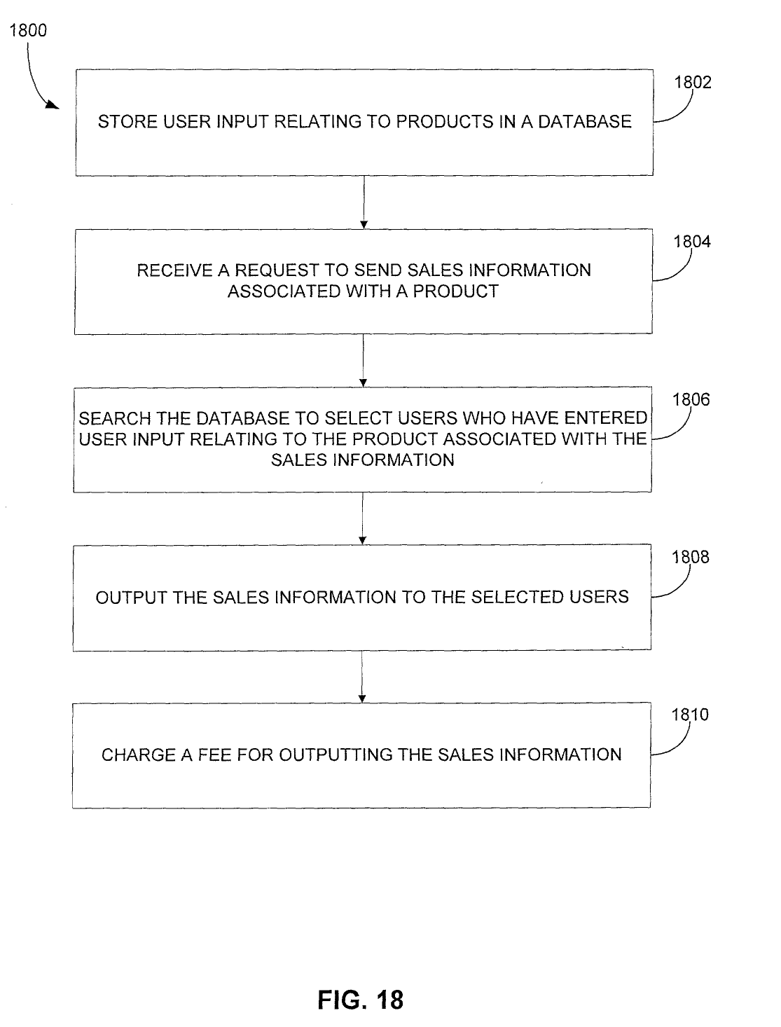

FIG. 18 is a flow diagram depicting a process 1800 for distributing targeted sales information. In operation 1802, user input relating to products is stored in a database. A request to send sales information associated with a product is received in operation 1804. The database is searched in operation 1806 for selecting users who have entered user input relating to the product associated with the sales information. In operation 1808, the sales information is output to the selected users. In operation 1810, a fee is charged for outputting the sales information.

In one embodiment of the present invention, the user input includes submissions of representations of bar codes associated with products. Thus, a defined group that has already opted into the product set by scanning a barcode is sampled.

In another embodiment of the present invention, the sales information is output utilizing a web page. An additional fee is charged for selecting a positioning of the sales information on the web page. For example, a premium can be charged for top-center positioning on the web page.

In an embodiment of the present invention, the sales information is output to a client device of one or more of the users. Such client device can be: a personal computer, a scanner with a display mechanism, a portable computing device such as a laptop computer, PDA, etc., a wireless or hard wired telephone, a pager, a facsimile machine, etc.

An additional fee can be charged for outputting the sales information to a telephone, pager, and/or portable computing device. A premium can also be charged for the delivery of first position to cell phones, pager, telephone, etc.

As an option, a user response to the sales information can be tracked. As another option, a promoter (i.e., vendor, manufacturer, marketer, etc.) of the product can be allowed to provide dynamic feedback to a user who is responding to the sales information.

Driving a User to Entertainment Programming

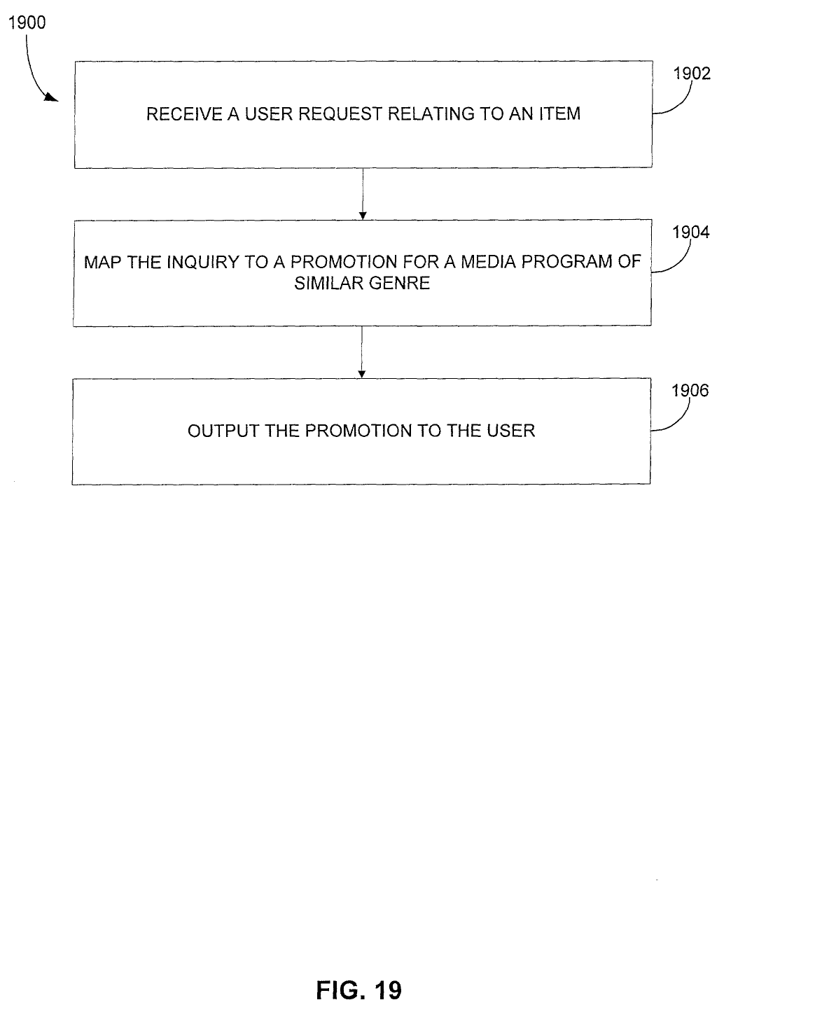

FIG. 19 depicts a process 1900 for promoting entertainment programs. In operation 1902, a request relating to an item is received from a user utilizing a network such as the Internet. The item can be a product, or simply a content item. In operation 1904, the inquiry is mapped to a promotion for a media program of a similar genre as the item. Whether they are in a similar genre can be determined by categorizing the product and then selecting the promotion based on the categorization (or vice versa). The promotion is output to the user in operation 1906 utilizing a network. For example, when a shopper uploads a book, music, video in the “romance” category, the present invention delivers a promotion for a real-world TV show or Cinematic Movie that is of the “romance” genre. The result is to effectively drive shoppers to entertainment programming based on their product desires.

In one embodiment of the present invention, the request is for uploading at least one of text, video, and audio. In another embodiment of the present invention, the media program is a television program, a cinematic movie, an audio production, etc. Optionally, an opportunity can be presented for programming a user's client device for recording the media program. For example, the present invention could deliver the “ad” to the web page and upon clicking on the ad, it could present a web-based opportunity to program either a VCR or a TIVO® Personal TV unit to record the show. TIVO currently is programmed through a TV interface that connects to a central database through a telephone connection.

Bidding System Based on User Demand

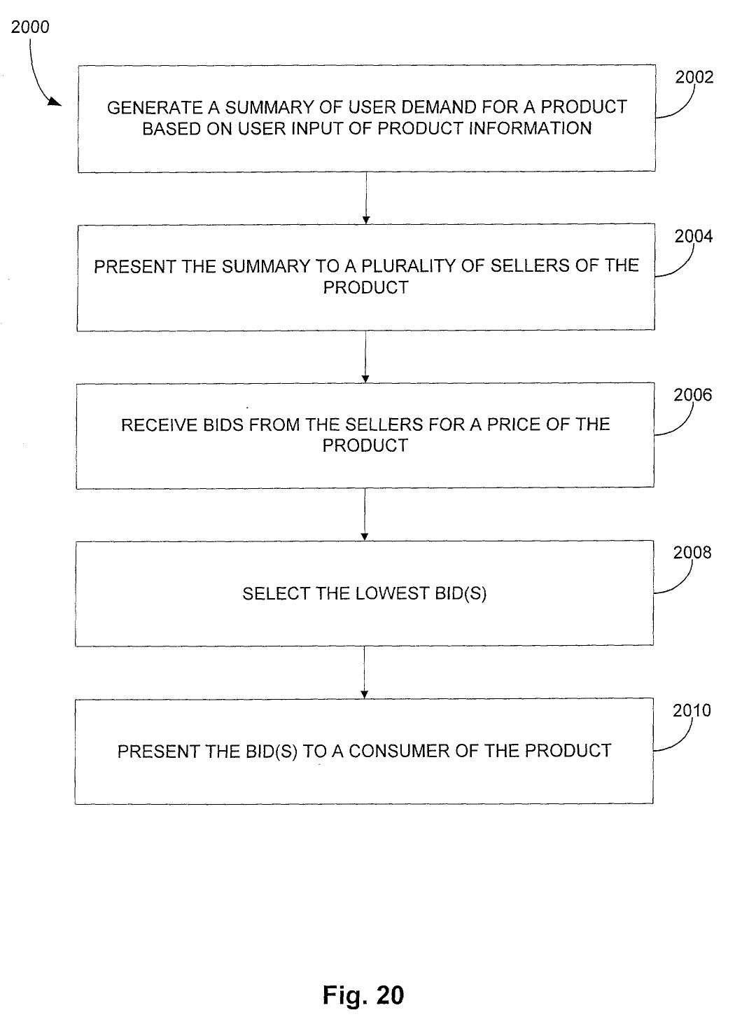

FIG. 20 illustrates a process 2000 for allowing bidding on products. A summary of user demand for a product is generated in operation 2002 based on user input of product information. In operation 2004, the summary is presented to a plurality of sellers of the product. In operation 2006, bids are received from the sellers for a price of the product. The bid can be based at least in part on the summary. The lowest bid (or bids) is selected in operation 2008, and is presented to a consumer of the product in operation 2010. Note that the consumer can be an end consumer, a reseller, or anyone else that would purchase the product.

In one embodiment of the present invention, the user input includes representations of bar codes, where the bar codes are associated with particular products. In another embodiment, the user input product information includes a survey relating to the product. The survey is preferably completed online (i.e., on the Internet).

In another embodiment of the present invention, the process of the present invention is performed in real time thus creating an open market with dynamic pricing. In this scenario, a group of marketing people would be looking at the market for the particular product and, for example, would bid 80 cents off for the particular product and auction for the particular product.

In yet another embodiment of the present invention, the summary includes a general geographic profile and/or a general demographic profile of the users inputting the product information. As an option, the bid can also (or alternatively) be presented to a user (e.g., end consumer).

Real Time Test Marketing

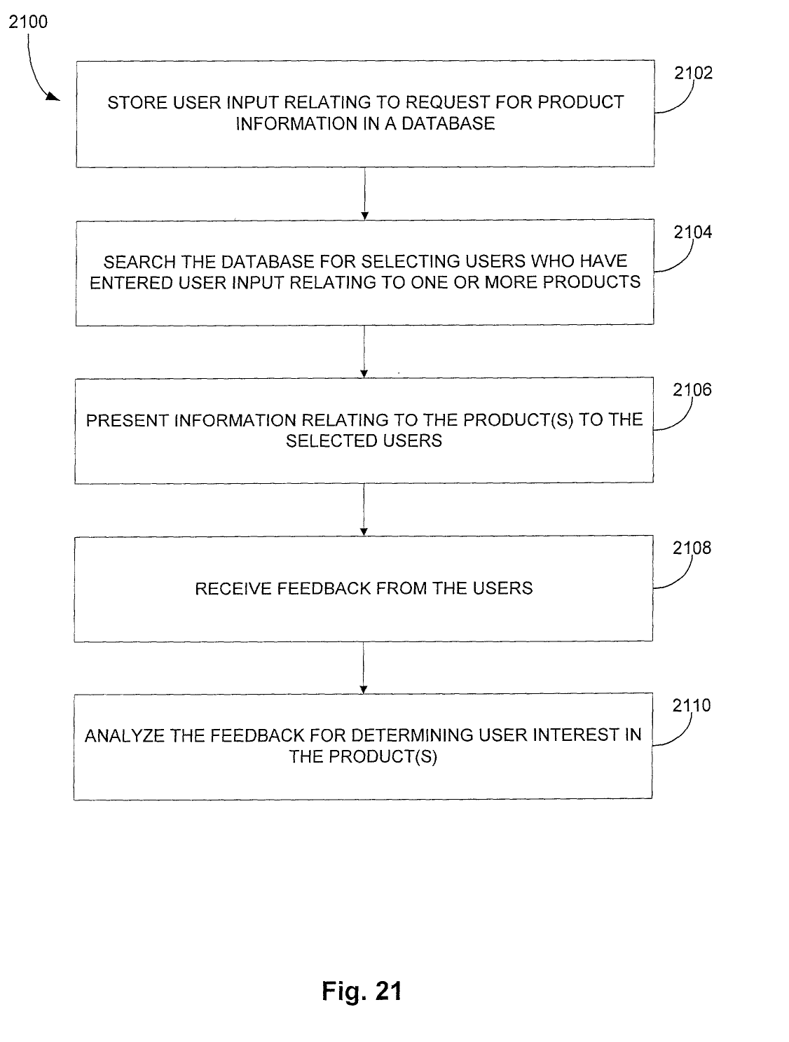

FIG. 21 depicts a process 2100 for test marketing in real time based on user polls. User input relating to requests for information about products is stored in a database in operation 2102. In operation 2104, a search is performed in the database for selecting users who have entered user input relating to at least one product. Information relating to the product(s) is presented to the selected users in operation 2106. Feedback is received from the users in operation 2108. In operation 2110, the feedback is analyzed for determining user interest in the at least one product. This allows a statistical analysis based on aggregated desires from the consumer database to determine the best coupon offering for clients. For example, the present invention allows a polling of clients with various offerings to see what dog food their dogs respond to.

In one embodiment, the user input includes submissions of representations of bar codes associated with products. Thus, a defined group that has already opted into the product set by scanning a barcode is sampled. In another embodiment, the information presented to the users includes a poll. In a further embodiment, the information presented to the users includes a promotional offer such as a sale price, rebate, discount, etc.

According to an embodiment of the present invention, the analysis includes a geographical analysis. As an option, the analysis can include a time period-based (i.e., day/week based) analysis. In a preferred embodiment of the present invention, the process is carried out by an extranet toolset available to merchants and marketers with specific price fields, promotion fields, dates, codes, etc. necessary to legitimatize the promotion.

Terminal/Kiosk

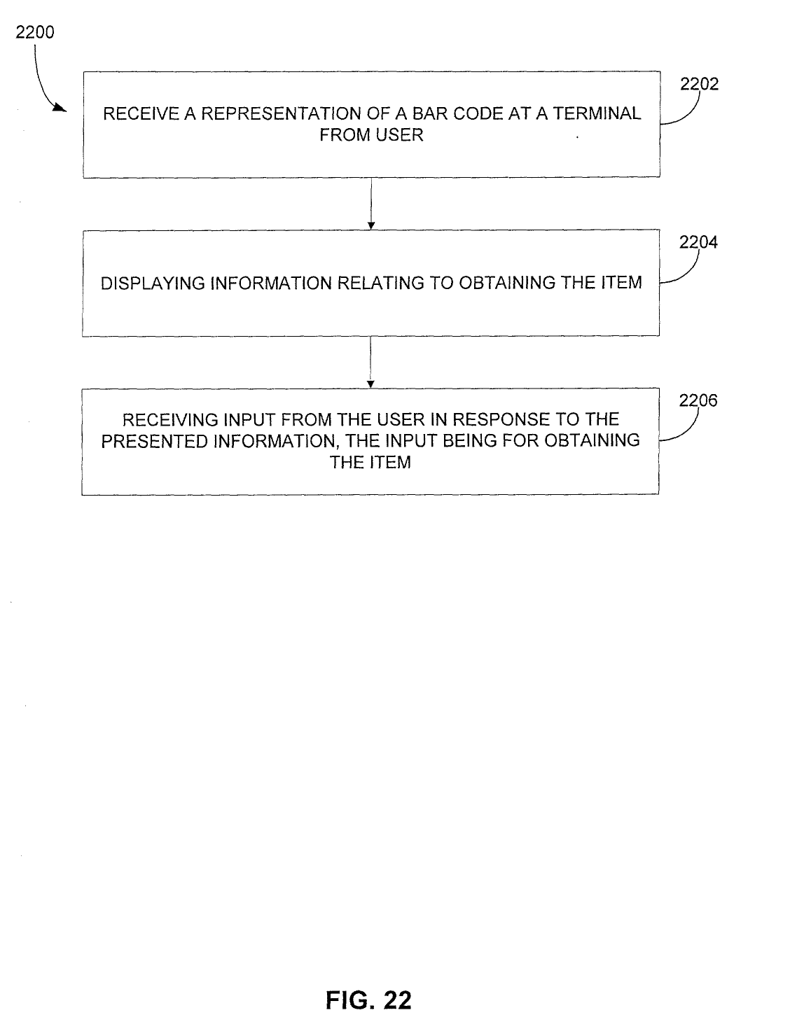

FIG. 22 depicts a process 2200 for bar code-based electronic commerce. In operation 2202, a representation of a bar code is received from a user at a terminal such as a kiosk. The representation of the bar code is obtained by scanning a bar code of an item. Note that the bar code can have been previously scanned by the user using another device, or can be scanned at the terminal. In operation 2204, information relating to obtaining use of or ownership of the item is presented on a display of the terminal. In operation 2206, input relating to obtaining use of or ownership of the item is received from the user in response to the presented information.

In one embodiment of the present invention, the item is a rental item such as a rental car. The information presented includes rental information including items such as cost per day/hour, desired duration of the rental, any special options (e.g., insurance, unlimited mileage), etc. Preferably, the user input includes payment information for paying a rent of the rental item. For example, the terminal can be a touchscreen kiosk at an airport adapted for manipulating rental car information. Bar codes are associated with rental cars. At the kiosk, the barcode of the car(s) desired is scanned. At the kiosk, the user can then go online and pay for the rental. Further, a bar code can be attached for the entire process. In other words, the information on the barcode can include every aspect of the rental, including rental price, promotional pricing, etc.

In another embodiment of the present invention, the item is a product. The terminal dispenses the product upon receiving payment information such as a credit card number, account number, etc. for payment from the user. In a further embodiment of the present invention, the item is a product and the terminal dispenses a ticket upon receiving payment information from the user. The ticket can then be exchanged for possession of the product.

In yet another embodiment of the present invention, the item is a product. In this embodiment, the product is sent to the user after receiving payment information from the user. The product can be sent using a delivery service such as the US Postal Service or, if electronic such as an eTicket used by major airlines, via email.

Recipe/Ingredient Selection

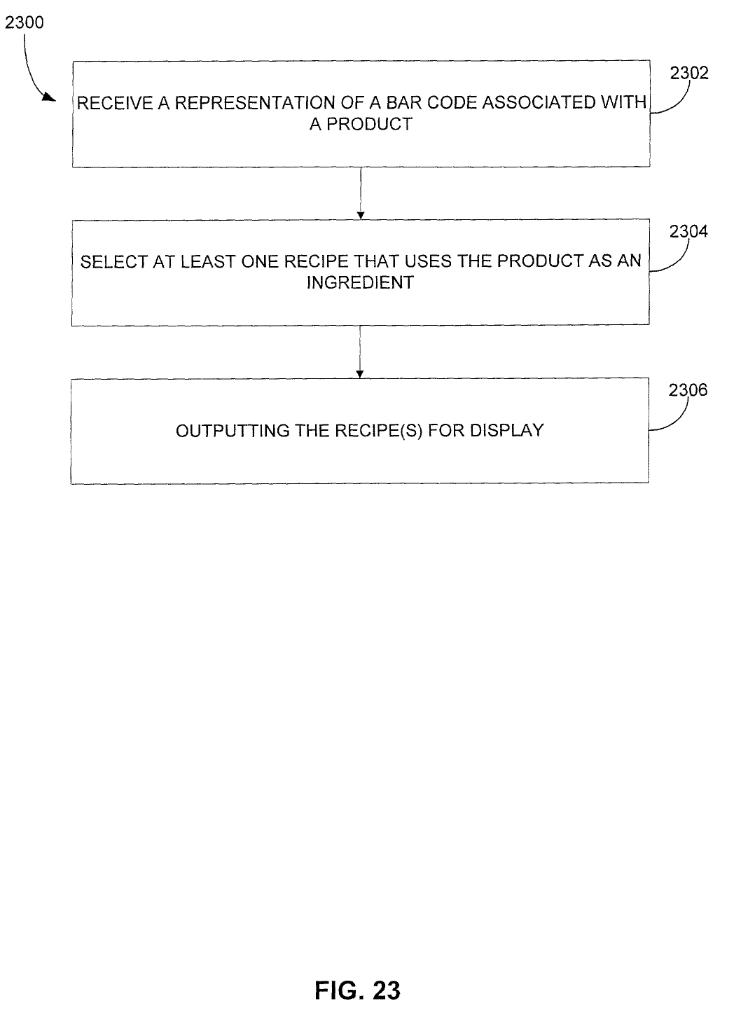

FIG. 23 illustrates a process 2300 for presenting a recipe based on bar code information. A representation of a bar code that is associated with a product is received in operation 2302. One or more recipes that use the product as an ingredient are selected in operation 2304. In operation 2306, the recipe(s) are output for display.

In one embodiment of the present invention, the recipe uses a predetermined amount (percentage, etc.) of the products as ingredients. This can require that all of the products be ingredients of the recipe.

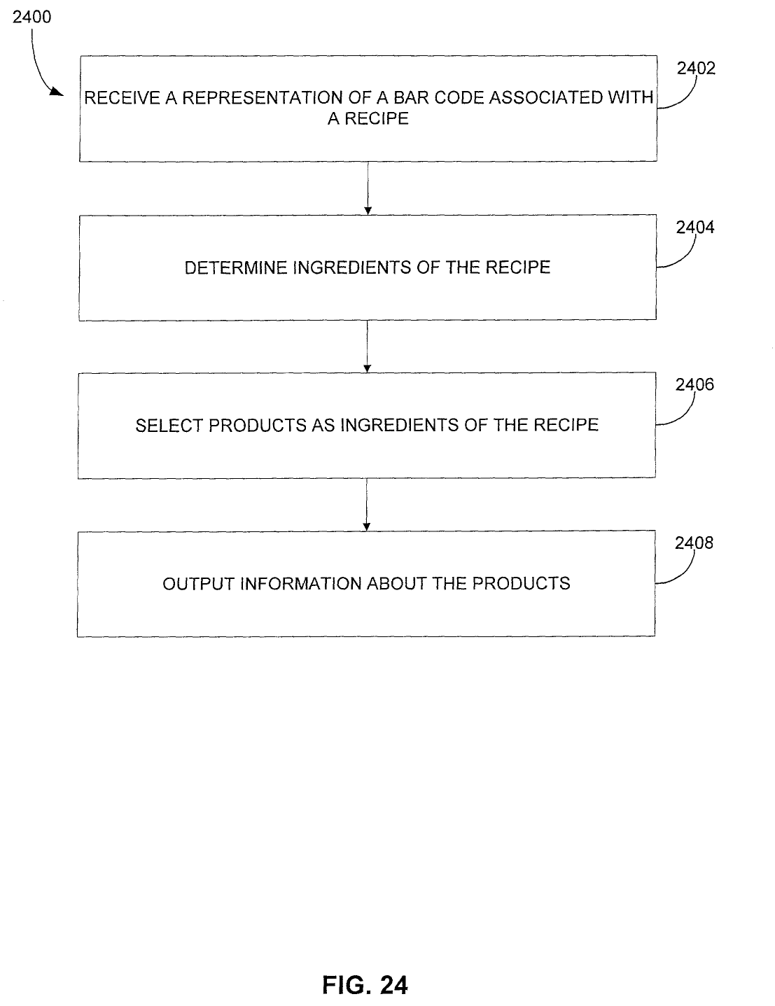

FIG. 24 depicts a process 2400 for presenting ingredients of a recipe based on bar code information. In operation 2402, a representation of a bar code associated with a recipe is received. The user can scan the bar code on the recipe with a scanning device or enter the barcode number. In operation 2404, the ingredients of the recipe are determined from information in a database. Products that can be used as ingredients of the recipe are selected in operation 2406. For example, Nestle® brand chocolate chips can be selected as the chocolate chips for a cookie recipe. Information about the products, such as the names of the products, is output in operation 2408.

In a preferred embodiment, the representation of the bar code is received from a remote user utilizing a network such as the Internet. As an option, the selected recipe(s) can be at a network site (i.e., website) for output to a client device of a user.

Scanning Device

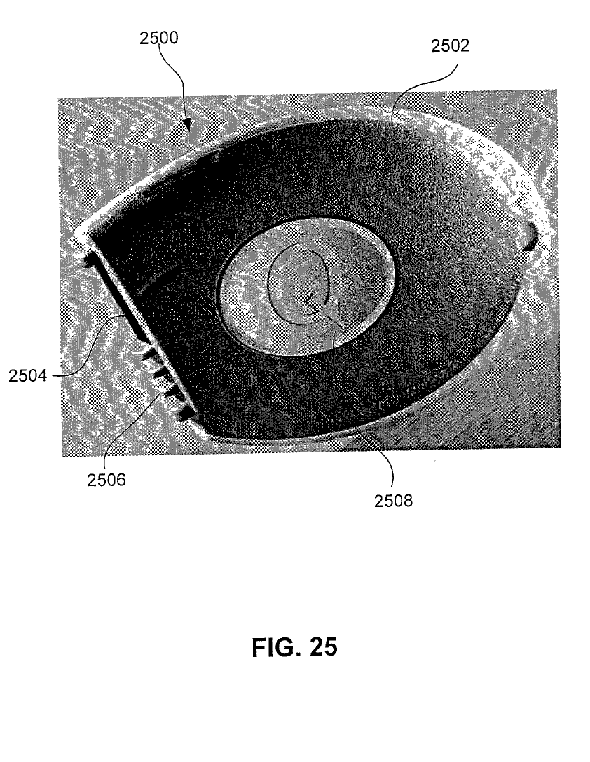

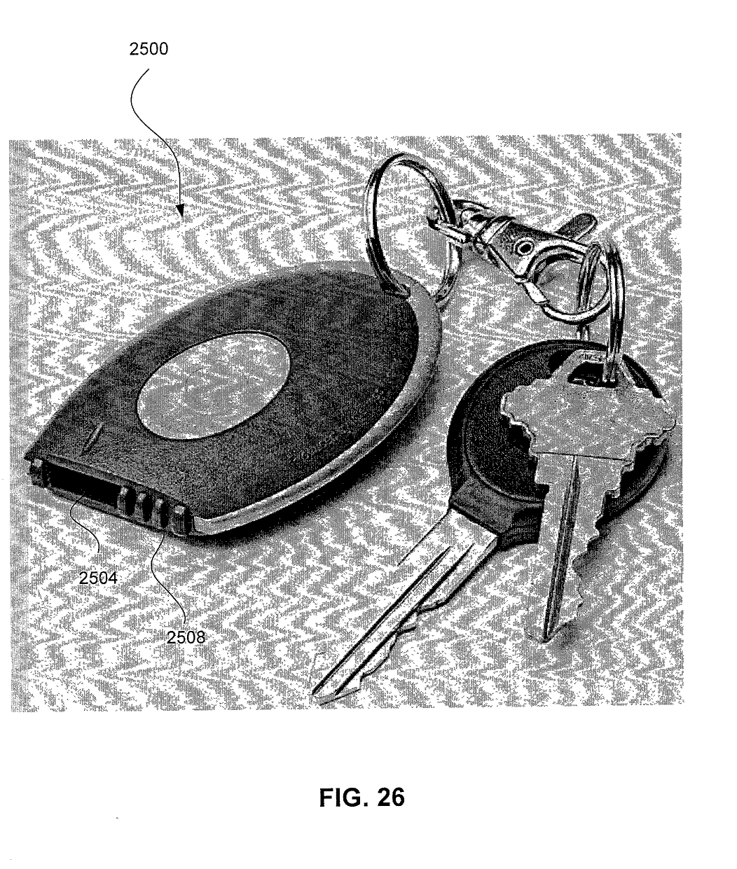

FIG. 25 is a side view of a bar code scanning device (scanner) 2500 according to an illustrative embodiment of the present invention. FIG. 26 is a perspective view of the bar code scanning device 2500 with keys attached. As shown in the FIGS. , the device includes a housing 2502 having a scanning port 2504. A button 2506 activates the scanning port. Optics (not shown) in the scanning port read the bar code as the device is passed over the bar code or vice versa. A memory (not shown) stores the bar codes for later retrieval from the device.

Guide flanges 2508 can be used to space the item being scanned from the scanning port to allow ambient light to illuminate the bar code. The device can also include a light source (not shown) to illuminate the bar code.

The scanning device records the bar codes of things in the real world. For example, when a user sees a new computer in a store, or a book at a friend's house, the user can just scan the bar code with the scanning device. In the past, the user would have had to make a note, or rely on memory. When the user gets home, the bar code information is read from the scanning device, such as a docking station.

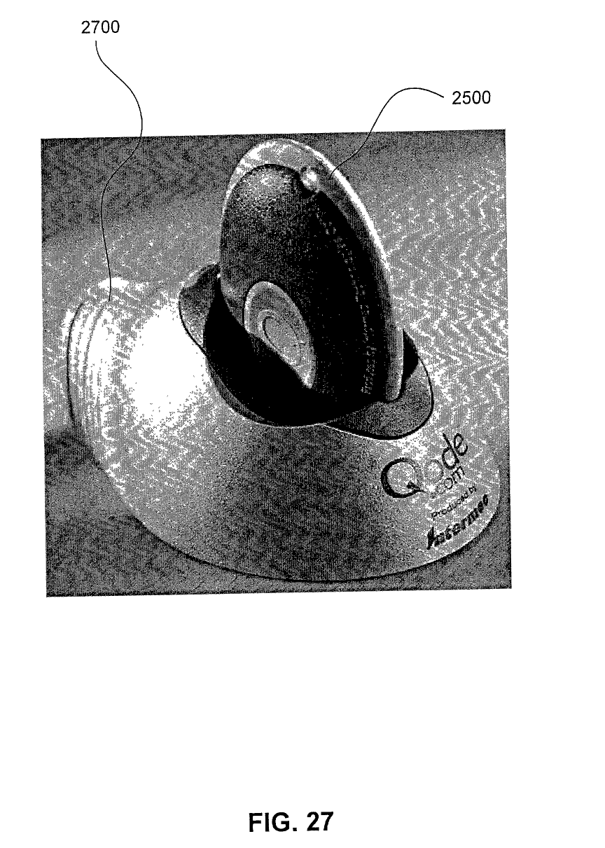

FIG. 27 is a perspective view of a docking station 2700 that can be used to transmit the bar code information stored in the scanning device to a host computer. Preferably, the docking station can retrieve the information from the scanner wirelessly, and send the information to the host computer wirelessly.

A bar code scanner is provided according to another embodiment of the present invention. The scanner includes a housing, which can be similar to the housing 2502 shown in FIGS. 25 and 26. A scanning portion (such as the scanning port 2504 of FIG. 25) is coupled to the housing and is operable to scan a bar code for generating an electronic representation of the bar code. A memory stores the bar code information, and is preferably able to store information from multiple bar codes. A communications portion is coupled to the housing and is operable to upload the representation of the bar code to a client device of a user. A transmitting portion is coupled to the housing and is operable to transmit the representation of the bar code to a remote device, either wirelessly or through physical medium. Again, the client device can be many things, such as a docking station, computer, telephone, PDA, etc. that receives transmissions from the transmitting portion of the scanner.

In one embodiment of the present invention, the remote device is a garage door opening mechanism such as one mounted in a garage for raising and lowing a garage door. In another embodiment of the present invention, the remote device is an automobile door lock system. In this embodiment, the scanner could also function as a remote controller for locking and unlocking the automobile. In either of these embodiments, a Radio Frequency (RF) signal can be used.

According to an embodiment of the present invention, the scanner includes a telephony portion operable for acquiring, sending and receiving voice data such that the scanner also operates as a telephone. The remote device can be a wireless telephone such as a cellular or digital wireless telephone. The remote device can be a wireless telephony receiving station. Carrier signals known in the art of wireless telephony can be used. In this embodiment, the scanner could also finction as a telephone. In another embodiment of the present invention, the remote device is a pager signal receiving station. In this embodiment, the scanner could also function as a pager.

In a further embodiment of the present invention, the bar code scanner also includes a display portion operable to display a representation of the bar code, such as its numerical equivalent. As an option, the display portion cam be operable to display information about an item associated with the bar code. For example, the item can be a product, a document, a web page, etc. Preferably, the transmitting portion is operable to wirelessly transmit the representation of the bar code to the remote device.

Hardware and Software Environment

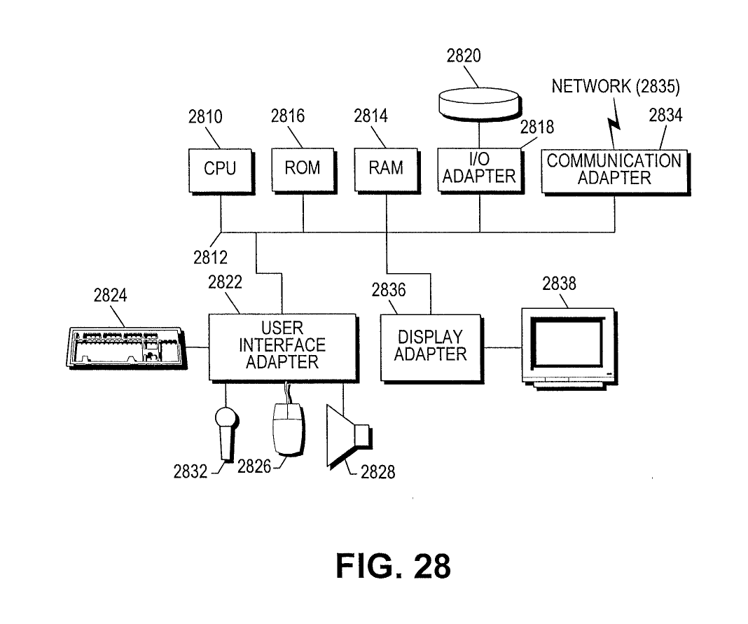

A preferred embodiment of a system in accordance with the present invention is preferably practiced in the context of a personal computer such as an IBM compatible personal computer, Apple Macintosh computer or UNIX based workstation. A representative hardware environment is depicted in FIG. 28, which illustrates a typical hardware configuration of a workstation in accordance with a preferred embodiment having a central processing unit 2810, such as a microprocessor, and a number of other units interconnected via a system bus 2812. The workstation shown in FIG. 28 includes a Random Access Memory (RAM) 2814, Read Only Memory (ROM) 2816, an I/O adapter 2818 for connecting peripheral devices such as disk storage units 2820 to the bus 2812, a user interface adapter 2822 for connecting a keyboard 2824, a mouse 2826, a speaker 2828, a microphone 2832, and/or other user interface devices such as a touch screen (not shown) to the bus 2812, communication adapter 2834 for connecting the workstation to a communication network (e.g., a data processing network) and a display adapter 2836 for connecting the bus 2812 to a display device 2838. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

A preferred embodiment is written using JAVA, C, and the C++ language and utilizes object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. A preferred embodiment of the invention utilizes HyperText Markup Language (HTML) to implement documents on the Internet together with a general-purpose secure communication protocol for a transport medium between the client and the Newco. HTTP or other protocols could be readily substituted for HTML without undue experimentation. Information on these products is available in T. Berners-Lee, D. Connoly, “RFC 1866: Hypertext Markup Language—2.0” (November 1995); and R. Fielding, H, Frystyk, T. Berners-Lee, J. Gettys and J.C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystem's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and clientside performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to JAVA is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for JAVA without undue experimentation to practice the invention.

Further Embodiments and Equivalents

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for distributing targeted sales information, comprising the steps of:
(a) storing user input relating to products in a database;
(b) receiving a request to send sales information associated with a product;
(c) searching the database for selecting users who have entered user input relating to the product associated with the sales information;
(d) outputting the sales information to the selected users; and
(e) charging a fee for outputting the sales information.

2. A method as recited in claim 1, wherein the user input includes submissions of representations of bar codes associated with products.

3. A method as recited in claim 1, wherein the sales information is output utilizing a web page, wherein an additional fee is charged for selecting a positioning of the sales information on the web page.

4. A method as recited in claim 1, wherein the sales information is output to a client device of at least one of the users, wherein the client device is selected from the group consisting of: a personal computer, a scanner, a portable computing device, a telephone, a pager, and a facsimile machine.

5. A method as recited in claim 1, wherein an additional fee is charged for outputting the sales information to at least one of a telephone, pager, and portable computing device.

6. A method as recited in claim 1, wherein a user response to the sales information is tracked.

7. A method as recited in claim 1, wherein a promoter of the product is allowed to provide dynamic feedback to a user responding to the sales information.

8. A computer program product for distributing targeted sales information, comprising:
(a) computer code for storing user input relating to products in a database;
(b) computer code for receiving a request to send sales information associated with a product;
(c) computer code for searching the database for selecting users who have entered user input relating to the product associated with the sales information;
(d) computer code for outputting the sales information to the selected users; and
(e) computer code for charging a fee for outputting the sales information.

9. A computer program product as recited in claim 8, wherein the user input includes submissions of representations of bar codes associated with products.

10. A computer program product as recited in claim 8, wherein the sales information is output utilizing a web page, wherein an additional fee is charged for selecting a positioning of the sales information on the web page.

11. A computer program product as recited in claim 8, wherein the sales information is output to a client device of at least one of the users, wherein the client device is selected from the group consisting of: a personal computer, a scanner, a portable computing device, a telephone, a pager, and a facsimile machine.

12. A computer program product as recited in claim 8, wherein an additional fee is charged for outputting the sales information to at least one of a telephone, pager, and portable computing device.

13. A computer program product as recited in claim 8, wherein a user response to the sales information is tracked.

14. A computer program product as recited in claim 8, wherein a promoter of the product is allowed to provide dynamic feedback to a user responding to the sales information.

15. A system for distributing targeted sales information, comprising:
(a) logic for storing user input relating to products in a database;
(b) logic for receiving a request to send sales information associated with a product;
(c) logic for searching the database for selecting users who have entered user input relating to the product associated with the sales information;
(d) logic for outputting the sales information to the selected users; and
(e) logic for charging a fee for outputting the sales information.

16. A system as recited in claim 15, wherein the user input includes submissions of representations of bar codes associated with products.

17. A system as recited in claim 15, wherein the sales information is output utilizing a web page, wherein an additional fee is charged for selecting a positioning of the sales information on the web page.

18. A system as recited in claim 15, wherein the sales information is output to a client device of at least one of the users, wherein the client device is selected from the group consisting of: a personal computer, a scanner, a portable computing device, a telephone, a pager, and a facsimile machine.

19. A system as recited in claim 15, wherein an additional fee is charged for outputting the sales information to at least one of a telephone, pager, and portable computing device.

20. A system as recited in claim 15, wherein a user response to the sales information is tracked.
